(19) United States
(12) Patent Application Publication
(10) Pub. No.: US 2011/0319247 A1
(43) Pub. Date: Dec. 29, 2011

(54) CENTRIFUGE SAMPLE CONTAINER AND CENTRIFUGE

(75) Inventors: Yoshimitsu KITAZAWA, Ibaraki (JP); Masaharu AIZAWA, Ibaraki (JP); Kenichi NEMOTO, Ibaraki (JP)

(73) Assignee: HITACHI KOKI CO., LTD., Tokyo (JP)

(21) Appl. No.: 13/168,907

(22) Filed: Jun. 24, 2011

(30) Foreign Application Priority Data
Jun. 28, 2010 (JP) P2010-145724

(51) Int. Cl. B04B 5/02; B04B 7/00

(52) U.S. Cl. 494/16; 422/548

(57) ABSTRACT

A centrifuge sample container includes: a body portion configured to contain a sample; and a cap portion configured to be engaged with and attached on the body portion. The body portion has a substantially triangular external shape defining three apex portions and three side portions between two of the apex portions when viewed from above and has a circular opening portion in an upper portion of the body portion. Distances between centers of the apex portions are equal to one another. Each of the apex portions is formed with a first radius of curvature when viewed from above. Each of the side portions is formed into a outwardly curved arc-like shape with a second radius of curvature when viewed from above.

### BACKGROUND

The present invention relates to a centrifuge for use in medical, pharmaceutical, genetic engineering fields, chemical, foods production and pharmaceuticals production industries and more particularly to a sample container for a centrifuge with an angle rotor which can increase an amount of liquid sample to be processed at one time.

A centrifuge for use in separating liquid samples includes a rotor in which a plurality of sample containers containing a liquid sample are held in sample container holding holes which are disposed at equal intervals in a circumferential direction and a driving unit such as a motor for driving to rotate the rotor. The centrifuge collects target substances by rotating the rotor at high speeds within a rotor chamber under the atmospheric or reduced pressure for centrifugally separating the liquid samples in the sample containers. Maximum rotation speeds of centrifuges to which the invention is mainly applied range approximately from 5,000 to 30,000 rpm and in such centrifuges, rotors of various specifications can be used in accordance with applications.

Liquid samples to be processed by such centrifuges include blood constituents, culture solutions of bacteria or viruses, organic constituents such as liquids containing DNA or RNA, polymeric aqueous suspensions, inks and food processing liquids. These liquid samples are subjected to centrifugal separation for various purposes in steps of research and experiment, inspection, production and the like.

For example, JP-A-2008-119649 discloses a known centrifuge rotor. FIG. 26 is a side view of a conventional angle rotor 230, in a left half of which a section of the rotor 230 is shown. In FIG. 26, a plurality of sample container holding holes 232 (only one of them is shown in FIG. 26) are formed at equal intervals in a circumferential direction in the rotor 230. A sample container 250 into which a liquid sample is poured is inserted in each holding hole 232. A rotor cover 240 is attached to an opening portion in an upper surface of the rotor 230, and an interior of the rotor 230 is sealed up by fixing the rotor cover 240 to a rotor body 231 using a handle 241. A drive shaft hole 231A is formed in an axial lower portion of the rotor body 231, and a drive shaft 212 of the centrifuge is attached in this drive shaft hole 231A, whereby the rotor 230 is rotated at a predetermined speed by a drive unit.

FIG. 27 is a perspective view showing a shape of a sample container 250 which is known in JP-A-2004-290746, and this sample container 250 is attached in a holding hole 232 in a conventional rotor body 231. Normally, in a centrifuge which employs a sample container with a lid, a body portion 251 of the sample container 250 has a cylindrical shape. A lid 252 of a screwed type is attached to an upper portion of the body portion 251 so as to seal a liquid sample in the sample container 250. The lid 252 is made up of an outer lid and an inner lid. Normally, the sample container 250 is a molded article molded of a plastic material such as polypropylene, polycarbonate, polystyrene, polyethylene terephthalate or the like, and the sample container 250 so molded is reused in many times. A cross-sectional shape of the body portion 251 and the lid 252 are a regular circular shape. Therefore, when the body portion 251 is inserted into the holding hole 232 in the rotor 230, the sample container 250 can be installed in an arbitrary position without paying any attention to the rotational position of the sample container 250 based on a longitudinal axis thereof. In the specification, the “cross section” means a section resulting from cutting the sample container along a plane normal to a vertical direction thereof.

As to sample containers 250 with a lid for use in angle rotors 230 like the rotor 230 described above, several types of sample containers 250 having different capacities ranging from on the order of 2 ml/container to 1000 ml/container are put in a practical use according to applications. The number of sample container holding holes 232 to be formed in the rotor 230 ranges variously from 4/rotor to on the order of 20/rotor. In general, these angle rotors 230 are formed by use of an aluminum alloy, a titanium alloy or a carbon fiber composite material. Several types of large-capacity angle rotors 230 are commercially available which include, for example, a rotor which accommodates 6 sample containers of 300 ml (hereinafter, referred to as a “300 ml×6 rotor”), a 500 ml×6 rotor and a 1,000 ml×4 to 6 rotor. As time goes by, the capacity of sample containers increases. In addition, as the capacity of sample containers increases, the size of rotors also increases. For example, rotors which employ sample containers of 300 ml to 1,000 ml include a rotor body of which a maximum diameter exceeds 300 mm in general.

Incidentally, the replacement of rotors of a centrifuge is performed by the operator. The manufacturers of centrifuges including the applicant of this patent application have made every effort to reduce the weight of rotors and increase the operability thereof. Further, the amount of sample to be centrifugally separated at one time has been attempted to be increased in association with the increase in capacity of sample containers. In recent years, centrifuges installing a large-capacity angle rotor of 1,000 ml×4 are now widely used. In addition, JP-A-2004-290746 discloses sample containers employed having a lid, and removal through holes 252A are formed in a lid 252 for facilitation of removal thereof and which prevent the leakage of a sample contained thereof during centrifugal separation.

### SUMMARY

In general, in order to collect target substances from liquid samples in a centrifugal separation process with good efficiency, a centrifugal acceleration imparted to liquid samples is increased by increasing the rotation speed of a rotor, so as to increase the centrifugal effect for quick settlement of target substances or to increase the recovery rate, so that the amount of sample that can be processed at one time is increased. In addition, in order to reduce costs involved in centrifugal separation, it is preferable to fabricate an inexpensive centrifuge including a rotor and further to increase the yield of centrifugal separation by increasing the amount of sample that can be subjected to centrifugal separation at one time.

In order to process a large amount of liquid sample by centrifugal separation at one time, it is effective to increase the number of sample containers attached in the rotor or to increase the capacity of each sample container. However, in order to increase the capacity of the conventional cylindrical sample container as it is, it is necessary to increase the outside diameter of the body portion 251 or to increase the height thereof. As this occurs, in the rotor, one sample container holding hole interferes with an adjacent holding hole, and therefore, it is necessary to shift the position where the holding holes are disposed further radially outwards (towards an outer circumferential side) from the rotation center. As a result, the diameter of the rotor itself is increased, which increases the mass of the rotor, and the carriage or attachment and detachment of the rotor to and from the centrifuge by the operator is deteriorated.

In addition, the increase in diameter of the rotor leads to an increase in air resistance (windage loss), and therefore, as countermeasures thereagainst, it is necessary to increase the output of the drive unit of the centrifuge and to increase the output of a cooling system for cooling the rotor. Further, the rotor chamber (the chamber) of the centrifuge needs to be enlarged in association with the increase in diameter of the rotor, and this increases the area where the centrifuge is installed, causing a problem that the price of the centrifuge is increased.

In the process of solving these problems, the inventors paid attention to the fact that rotor constituting member portions (hereinafter, referred to as “excess portions”) which constitute a cause for an increase in weight exist between the adjacent sample container holding holes when the rotor which holds the cylindrical sample containers is viewed from above and tried to reduce these excess portions to as low level as possible for improvement in weight reduction. In addition, in the process of improving the weight reduction, the inventors also found out that the excess portions in the vicinity of the outer circumference of the rotor constituted one of causes for increasing the mass of the rotor and that the excess portions caused a reduction in strength of the rotor due to centrifugal load exerted to these excess portions.

In view of the above, an object of one aspect of the disclosure is to provide a centrifuge sample container which can increase an amount of sample to be subjected to centrifugal separation at one time while suppressing the increase in diameter and weight of the rotor.

Another object is to provide a centrifuge sample container which enables centrifugal separation work to be carried out with good efficiency within a short period of time by increasing the centrifugal separation performance.

A further object is to provide a centrifuge sample container which can prevent an attachment failure of auxiliary members, which can avoid as much possibility to reduce its service life as possible, which has superior durability and which is easy to be handled.

The aspect of the disclosure provides the following arrangements:
(1) A centrifuge sample container comprising:

a body portion configured to contain a sample and having a circular opening portion in an upper portion of the body portion; and

a cap portion configured to be engaged with and attached on the body portion,

wherein the body portion has a substantially triangular external shape defining three apex portions and three side portions between two of the apex portions when viewed from above,

wherein distances between centers of the apex portions are equal to one another,

wherein each of the apex portions is formed with a first radius of curvature when viewed from above, and

wherein each of the side portions is formed into a outwardly curved arc-like shape with a second radius of curvature when viewed from above.
(2) The centrifuge sample container according to (1), wherein

an outline of the external shape of the body portion is located further outwards than the opening portion when viewed from above, and

a neck support portion having the same shape as the external shape of the body portion is formed on the cap portion.
(3) The centrifuge sample container according to (2), wherein

the cap portion includes:

an inner lid which is secured in the opening portion while a closing member is interposed between an upper end face of the opening portion and the inner lid; and

an outer lid which is engaged with the body portion so as to cover the opening portion and the inner lid, and

the neck support portion is formed on the outer lid.
(4) The centrifuge sample container according to (3) further comprising an engaging unit configured engage the cap portion with the body portion,

wherein the outer lid includes a lower inner circumferential surface formed into a cylindrical shape,

wherein when the cap portion is engaged with the opening portion by the engaging unit, the substantially triangular shape of the body portion coincides with a substantially triangular shape of the outer lid when viewed from above.
(5) The centrifuge sample container according to (4), wherein

the engaging unit includes a projecting portion which is formed on the inner circumferential surface and projects radially inwardly,

the engaging unit includes a circumferential groove which is formed on an outer circumferential side of the opening portion, and

the cap portion is held so as not to be shifted in an axial direction when the projecting portion enters the circumferential groove.
(6) The centrifuge sample container according to (5), wherein a plurality of the projecting portions are formed on the inner circumferential surface of the outer lid, and a plurality of the circumferential grooves are formed on the outer circumferential side of the opening portion.
(7) The centrifuge sample container according to (5), wherein

the engaging unit includes:

an axial groove which is formed on the body portion extends from an opening surface of the opening portion in an axial direction; and

a circumferential groove which extends in a circumferential direction from a distal end side of the axial groove, and

the cap portion is pushed axial downwards relative to the body portion and is then turned through a predetermined angle so that the projecting portion is positioned in the circumferential groove.
(8) The centrifuge sample container according to (7), wherein

a length of the circumferential groove which extends from the axial groove is set so that a rotation angle of the cap portion becomes smaller than about 120 degrees in the circumferential direction.
(9) The centrifuge sample container according to (1), wherein

a through hole in which a thread is formed is provided in the outer lid, and

a push piece configured to push the inner lid is attached in the through hole.
(10) A centrifuge sample container comprising:

a body portion configured to contain a sample and having a circular opening portion in an upper portion of the body portion;

a cap portion configured to be attached on the body portion;

an engaging unit configured engage the cap portion with the body portion,

wherein the cap portion includes:

an inner lid which is secured in the opening portion while a closing member is interposed between an upper end face of the opening portion and the inner lid; and

an outer lid which is engaged with the body portion so as to cover the opening portion and the inner lid, and

wherein the outer lid includes a lower inner circumferential surface formed into a cylindrical shape,

wherein the engaging unit is provided on an outer circumferential surface of the opening portion and the inner circumferential surface of the outer lid,

wherein a through hole is formed through the outer lid and a thread is formed on the through hole, and

wherein a push piece configured to push the inner lid is attached in the through hole.
(11) The centrifuge sample container according to (10), wherein

the engaging unit includes a projecting portion which is formed on the inner circumferential surface and projects radially inwardly, and

the engaging unit includes a circumferential groove which is formed on the outer circumferential surface of the opening portion, and

the cap portion is held so as not to be shifted in an axial direction when the projecting portion enters the circumferential groove.
(12) The centrifuge sample container according to (11), wherein a plurality of the projecting portions are formed on the inner circumferential surface of the outer lid, and a plurality of the circumferential grooves are formed on the outer circumferential side of the opening portion.
(13) The centrifuge sample container according to (12), wherein

the engaging unit includes:

an axial groove which is formed on the body portion extends from an opening surface of the opening portion in an axial direction; and

a circumferential groove which extends in a circumferential direction from a distal end side of the axial groove, and

the cap portion is pushed axial downwards relative to the body portion and is then turned through a predetermined angle so that the projecting portion is positioned in the circumferential groove.
(14) The centrifuge sample container according to (13), wherein

a length of the circumferential groove which extends from the axial groove is set so that a rotation angle of the cap portion becomes smaller than about 120 degrees in the circumferential direction.
(15) A centrifuge comprising:

a rotor which includes a holding portion;

a motor which is configured to rotate the rotor;

a rotor chamber which accommodates the rotor; and

the centrifuge sample container described in (1), which is attached in the holding portion of the rotor.
(16) A centrifuge comprising:

a rotor which includes a holding portion;

a motor which is configured to rotate the rotor;

a rotor chamber which accommodates the rotor; and

the centrifuge sample container described in (10), which is attached in the holding portion of the rotor.

According to the first aspect, the body portion has the substantially triangular external shape when viewed from above and has the circular opening portion in the upper portion thereof and the cap portion can be attached to and detached from the body portion through engaging. Thus, compared with the conventional cylindrical sample container, the sample container can be realized which can easily be attached and detached while containing a large amount of sample. In addition, the body portion is formed by combining the plurality of shapes with the different radii of curvatures, and therefore, the strength of the sample container can be increased.

According to the second aspect, the neck support portion having the same shape as the external shape of the body portion is formed integrally on the cap portion. Therefore, the operator does not have to worry about the failure to attach the neck support member, and the deformation or failure of the lid portion and the opening portion of the sample container due to the centrifugal force can be prevented. In addition, even in the event that the centrifugal force is applied thereto, since the shape of the outer circumferential portion of the outer lid matches the shape of the sample container holding hole in the rotor and the outer lid fits in the sample container with no gap formed therebetween, the deformation of the opening portion of the sample container and the cap portion due to the centrifugal force can be prevented.

According to the third aspect, the cap portion is formed so as to have the inner lid which is fittingly secured in the opening portion to thereby interpose the closing member between the upper end face of the opening portion and itself and the outer lid which is engaged with the body portion so as to cover the opening portion and the inner lid, and the neck support portion is formed on the outer lid. Thus, the sample container can be provided which ensures the sealing of the container without damaging the sealing performance of containing the sample liquid therein without any leakage therefrom.

According to the fourth aspect, when the cap portion is engaged with the opening portion by the engaging unit, the substantially triangular shape of the body portion and the substantially triangular shape of the outer lid coincide with each other in position when viewed from above. Thus, when the cap portion is not fastened properly, the substantially triangular shape of the body portion and the substantially triangular shape of the outer lid do not coincide with each other in position. Therefore, the operator can visually confirm at a glance whether the sample container is closed properly or is left open. In addition, the sample container cannot be attached in the holding hole in the rotor unless the cap portion is properly closed. Therefore, there can be eliminated a risk of leakage of the sample due to the failure to fasten the cap portion properly.

According to the fifth aspect, the engaging unit is formed by the projecting portion on the cap portion and the circumferential groove which is formed on the outer circumferential side of the opening portion, and therefore, the engaging unit can easily be fabricated in the molding process of the cap portion and the sample container, thereby making it possible to suppress the fabrication costs to an inexpensive level. In addition, the projecting portion and the groove portion can be formed much wider than the pitch of the thread, thereby making it possible to realize the sample container which is easy to be washed and handled.

According to the sixth aspect, the plurality of engaging unit like the engaging unit are provided circumferentially on the cap portion and the plurality of engaging unit like the engaging unit are provided circumferentially on the body portion. Therefore, the cap portion can be fixed to the body portion in an ensured fashion.

According to the seventh aspect, the length of the circumferential groove which extends from the axial groove is set so that the rotation angle of the cap portion becomes smaller than about 120 degrees in the circumferential direction, and therefore, the operator can easily open and close the cap portion only by twisting it by one hand.

According to the eighth aspect, the length of the circumferential groove which extends from the axial groove is set so that the rotation angle of the cap portion becomes smaller than about 120 degrees in the circumferential direction, and therefore, engaging unit can be disposed at three locations or more in the circumferential direction, thereby making it possible to hold the cap portion stably.

According to the ninth aspect, the through hole in which the thread is formed is provided in the outer lid, and the push piece adapted to push the inner lid is installed in the through hole. Therefore, the closing member between the sample container and the inner lid can be compressed, thereby making it possible to ensure a sufficient sealing performance of the sample container to prevent the leakage of the sample therefrom.

According to the tenth aspect, the cap portion can be attached to and detached from the body portion through engaging, and therefore, the operator can easily open and close the sample container only by twisting the cap portion by one hand. In addition, the through hole in which the thread is formed is provided in the outer lid, and the push piece adapted to push the inner lid is installed in the through hole. Therefore, the closing member between the sample container and the inner lid can be compressed sufficiently, thereby making it possible to ensure a sufficient sealing performance of the sample container to prevent the leakage of the sample therefrom.

According to the eleventh aspect, the cap portion is held so as not to be shifted axially when the projecting portion on the outer lid enters the circumferential groove. Therefore, the cap portion can be held firmly so as not to be dislodged from the body portion even though the cap portion is configured so as to easily be attached to and detached from the body portion.

According to the twelfth aspect, the plurality of engaging unit like the engaging unit are provided circumferentially on the cap portion and the plurality of engaging unit like the engaging unit are provided circumferentially on the body portion. Therefore, the cap portion can be fixed to the body portion in an ensured fashion.

According to the thirteenth aspect, the length of the circumferential groove which extends from the axial groove is set so that the rotation angle of the cap portion becomes smaller than about 120 degrees in the circumferential direction, and therefore, the operator can easily open and close the cap portion only by twisting it by one hand.

According to the fourteenth aspect, the length of the circumferential groove which extends from the axial groove is set so that the rotation angle of the cap portion becomes smaller than about 120 degrees in the circumferential direction, and therefore, engaging unit can be disposed at three locations or more in the circumferential direction, thereby making it possible to hold the cap portion stably.

### BRIEF DESCRIPTION OF THE DRAWINGS

FIG. 1 is a partially sectional front view of a centrifuge 1 according to an embodiment of the invention.

FIG. 2 is a vertical sectional view of a rotor 30 according to the embodiment of the invention.

FIG. 3 is a perspective view showing an external appearance of a sample container 50 according to the embodiment of the invention.

FIG. 4 is a perspective view of a rotor body 31 according to the embodiment of the invention.

FIG. 5 is a top view of the rotor body 31 according to the embodiment of the invention.

FIG. 6 is a top view of a state in which sample containers 50 are attached in the rotor body 31 according to the embodiment of the invention.

FIGS. 7A and 7B shows top views of the sample container 50 according to the embodiment of the invention, of which FIG. 7A shows a state in which a cap portion 52 is attached, and FIG. 7B shows a state in which the cap portion 52 is removed.

FIG. 8 is a vertical sectional view of the sample container 50 according to the embodiment of the invention.

FIGS. 9A and 9B show a shape of a neck support member 70 in FIG. 2, of which FIG. 9A is a perspective view, and FIG. 9B is a top view of the neck support member 70.

FIG. 10 is a top view showing a state in which the sample containers 50 and the neck support member 70 are attached in the rotor body 31 according to the embodiment of the invention.

FIG. 11 is a vertical sectional view of the sample container according to the embodiment of the invention and shows a state in which a sample is poured to a maximum capacity of the container.

FIG. 12 is a vertical sectional view of the rotor 30 of the embodiment of the invention.

FIG. 13 is a sectional view taken along a portion indicated by arrows A, A.

FIG. 14 is a diagram showing a positional relationship between the shape of a body portion 51 of the sample container 50 according to the embodiment and the shape of a body portion 251 of a conventional cylindrical sample container 250 for comparison.

FIG. 15 is a diagram showing a relationship between a horizontal sectional shape of a holding hole 32 in the section taken along the portion indicted by the arrows A, A in FIG. 12 and a direction in which centrifugal force is exerted.

FIG. 16 is an exemplary diagram showing centrifugal separation conditions by the sample container 50 of the invention and the conventional sample container 250 which is circular in section.

FIG. 17 is a diagram showing a state in which the sample container 50 according to the embodiment of the invention is laid horizontally.

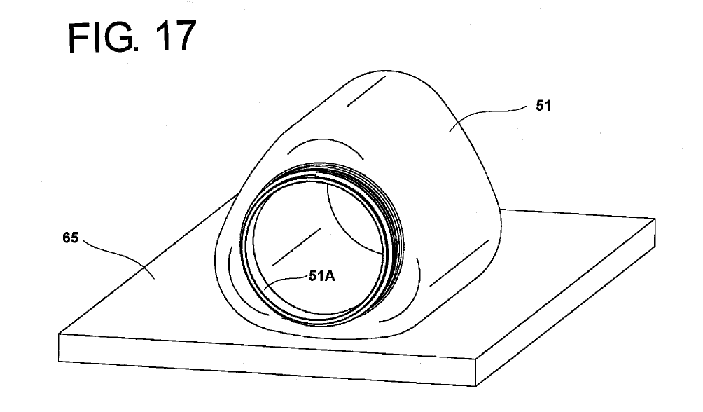

FIG. 18 is a top view showing a state in which the sample containers 50 and the neck support member 70 are attached in a rotor 45 having a different shape.

FIG. 19 is an exploded perspective view showing an external appearance of a sample container 80 according to a second embodiment of the invention.

FIGS. 20A and 20B shows top views of the sample container 80 according to the second embodiment of the invention, of which FIG. 20A shows a state in which a cap portion 82 is attached, and FIG. 20B shows a state in which the cap portion 82 is removed.

FIG. 21 is a vertical sectional view of the sample container 80 according the second embodiment of the invention.

FIG. 22 shows a sectional view of an outer lid 83 according to the second embodiment of the invention and a partial side view of a body portion 81 in the vicinity of an opening portion 81A.

FIG. 23 is a vertical sectional view showing a condition in which the sample containers 80 according to the second embodiment of the invention are attached in a rotor 130.

FIG. 24 is an exploded perspective view showing an external appearance of a sample container 100 according to a third embodiment of the invention.

FIG. 25 is a vertical sectional view of the sample container 100 according to the third embodiment of the invention.

FIG. 26 shows a side view of a conventional angle rotor 230 with a section thereof shown in a left half portion thereof.

FIG. 27 is a perspective view showing a shape of the conventional sample container 250.

### DESCRIPTION OF EXEMPLARY EMBODIMENTS

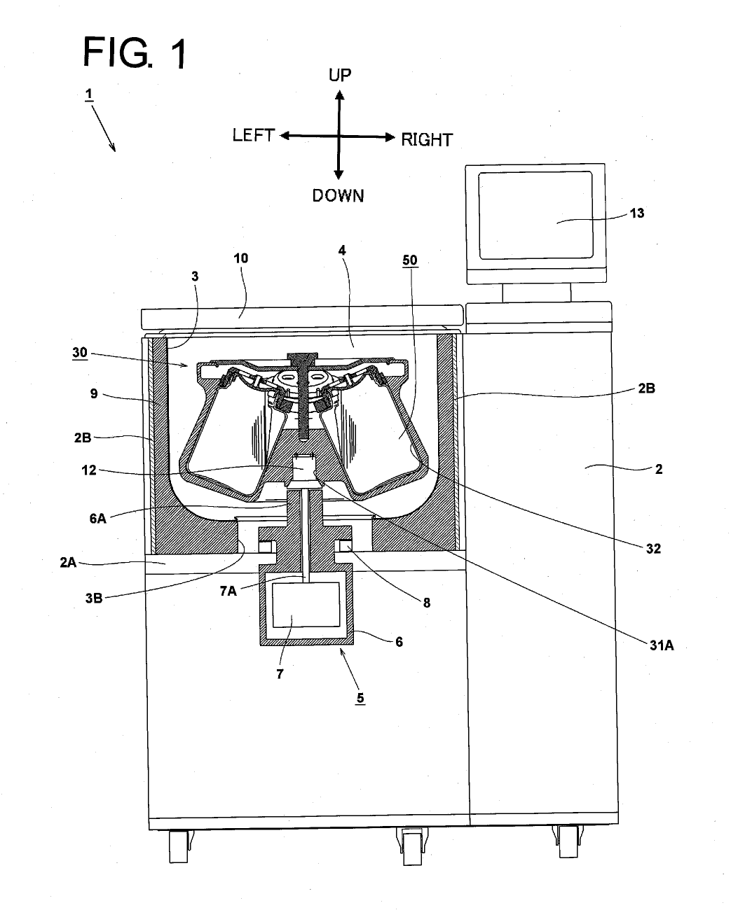

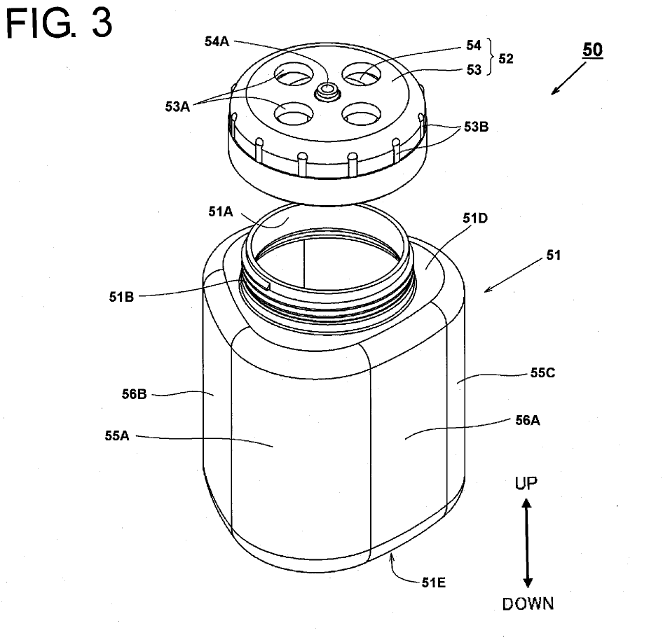

Hereinafter, exemplary embodiments of the invention will be described by reference to the drawings. In the drawings, same reference numerals will be given to same portions, and the repetition of the same description will be omitted. In this specification, directions shown in FIG. 1 denote vertical and left-to-right directions of a centrifuge, and a direction shown in FIG. 3 denotes a vertical direction of a sample container.

### First Embodiment

FIG. 1 is a partially sectional front view of a centrifuge 1 of the invention. The centrifuge 1 includes a rectangular parallelepiped box-shaped housing 2, and an interior of the housing 2 is partitioned into upper and lower spaces by a horizontal partition plate 2A. A cylindrical chamber 3 which is opened in an upper surface is provided in the upper space so partitioned. A coolant circulation pipe, not shown, is attached to an outer circumferential portion of the chamber 3, and when a coolant supplied from a cooling machine, not shown, which is provided within the centrifuge 1 is circulated through the pipe, an interior space of the chamber 3, that is, a rotor chamber 4 is cooled. A heat insulation material 9 and a protection wall 2B are provided around the circumference of the chamber 3. A door 10, which can be opened and closed, is provided on an upper side of the chamber 3, and the rotor chamber 4 is closed tightly when the door 10 is closed. A rotor 30 is accommodated within the rotor chamber 4. A control and display unit 13 is provided on a right-hand side of an upper portion of the housing 2.

A drive unit 5 is attached to the partition plate 2A within the lower space partitioned by the partition plate 2A within the housing 2. The drive unit 5 includes a motor housing 6, and an electric motor 7 is provided in an interior of the motor housing 6 as a drive source. The motor housing 6 is fixed to the partition plate 2 via a damper 8. A shaft support portion 6A is disposed on an upper side of the motor housing 6 so as to extend through a bottom portion of the chamber 3 to reach an interior of the rotor chamber 4. A rotational shaft 7A of the motor 7 is supported rotatably by the shaft support portion 6A and extends upwards as far as the interior of the rotor chamber 4. A drive shaft portion 12 is provided at an upper end portion of the rotational shaft 7A, and a drive shaft hole 31A is fixed to the drive shaft portion 12. The rotor 30 is detachably attached on the drive shaft portion 12 and is rotated by the motor 7. Normally, a rotor 30 is selected for installation, which has a number of holding holes which corresponds to a number of sample containers to be used. Sample containers 50 filled with samples are attached in the holding holes 32 formed in the rotor 30.

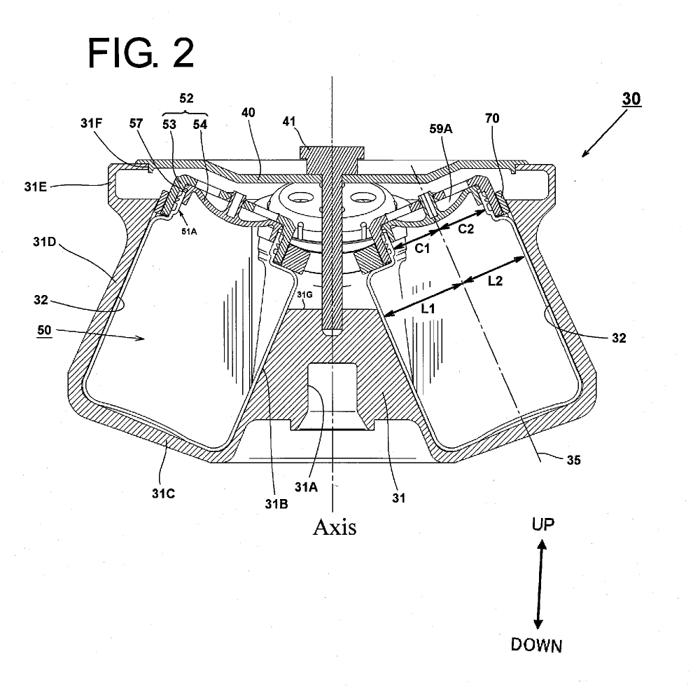

Nest, the rotor and the sample container will be described by reference to FIGS. 2 and 3. FIG. 2 is a vertical sectional view of the rotor 30. A plurality of sample container holding holes 32 are formed at equal angular intervals in a circumferential direction in the rotor 30. The sample containers 50 into which liquid samples are poured are attached in the holding holes 32. A liquid sealing annular groove 31E is provided on an upper side of the rotor 30 for preventing the leakage of liquid from the rotor 30 once the samples leak from the sample containers 50 during centrifugal separation. An opening portion 31F is formed in an upper portion of the liquid sealing annular groove 31E. A rotor cover 40 is attached to the opening portion 31F. This rotor cover 40 is screwed on to a rotor body 31 using a handle 41, whereby an interior of the rotor 30 is sealed up. The drive shaft hole 31A is formed in an axial lower portion of the rotor body 31 for installation on the drive shaft portion 12 of the drive unit 5. The drive shaft hole 31A is fixed to the drive shaft portion 12 so as not to rotate relatively thereto, and the drive shaft hole 31A can be so installed by use of a known installation method in the field of centrifuges. The rotor 30 installed by use of this installation method is driven to rotate at a predetermined speed by the motor 7.

An opening portion 51A is provided in an upper portion of the sample container 50, and a cap portion 52 is attached to the opening portion 51A. The cap portion 52 is made up of an outer lid 53 and an inner lid 54, and the opening portion 51A is sealed up by screwing the cap portion 52 to the opening portion 51A. It is characteristic of this embodiment that a distance L1 in a normal direction from a vertical center line 35 of the sample container 50 to an inner circumferential side wall of the container is much larger than a distance L2 from the center line 35 to an outer circumferential side wall of the container. On the other hand, in the opening portion 51A, a distance C1 from the center line 35 to an inner side of the opening portion is equal to a distance C2 to an outer side thereof. Note that these distances L1, L2, C1, C2 are measured in the normal direction from the center line 35. In addition, the center line 35 is a line which passes through a center position of the cap portion 52 or the opening portion 51A. The center line 35 is an imaginary line which passes through a center position (or the center of gravity) of a bottom surface of the container 50 and the center position of the cap portion 52 (a position where a projecting portion 54A, which will be described later, is present). A vertical positional relationship is established between the center line 35 and an upper surface of the outer lid 53.

FIG. 3 is a perspective view showing an external appearance of the sample container 50 and shows a state in which the cap portion 52 is removed. In FIG. 3, the sample container 50 is divided into a body portion 51 and the cap portion 52. The body portion 51 is a portion of the container in which a liquid sample to be subjected to centrifugal separation is contained. The circular opening portion 51A for putting in and taking out a sample is provided in an upper portion of the body portion 51. A male thread portion 51B is formed on an outer circumferential side of the opening portion 51A. As is shown in section in FIG. 2, an O-ring 57 (refer to FIG. 2) is attached to the inner lid 54 to seal up the opening portion 51A in the sample container 50, and the outer lid 53 is provided so as to cover them. A female thread portion 53B (which will be described later) is formed on an inner surface of the outer lid 53 so as to be screwed on the male thread portion 51B on the opening portion 51A of the body portion 51. A plurality of removal through holes 53A are formed in an upper portion of the outer lid 53 so as to pass therethrough to a space portion defined by the projecting portion 54A of the inner lid 54. By adopting this configuration, a space within the cap can be secured between the outer lid 53 and the inner lid 54. This space is formed so that a wider gap is defined between the outer lid 53 and the inner lid 54 as the space extends towards a central portion of the outer lid 53, and the gap defined between the outer lid 53 and the inner lid 54 is approximately 3 to 10 mm deep so that an adult can grip the cap portion 52 with his or her fingers. Thus, the through holes 53A can be gripped by the thumb and the index finger or with the middle finger added thereto, thereby making it possible to pull out the sample container 50 attached in the holding hole 32 in the rotor body 31.

The shape and number of through holes 53A are arbitrary, provided that the sample container 50 can be taken out easily. However, it is desirable that the through hole 53A is sized so as to admit the entrance of the tip of a finger, particularly, the thumb of the adult, and therefore, the through hole 53A has desirably a diameter of the order of 20 mm. Note that the through holes 53A do not always have to be provided. In the case of the rotor 30 of this embodiment, since the sample container 50 can be pulled out from the rotor body 31 by gripping the outer circumferential side of the cap portion 52, no through hole 53A may be provided. Slip preventive projections 53B are provided at equal intervals in a circumferential direction on an outer circumferential portion of the outer lid 53 so that the operator can grip to rotate the cap portion 52 easily.

The body portion 51 of the sample container 50 has a cross-sectional shape having substantially a regular triangle. Specifically, side portions (side portions 56A, 56B, 56C, in which the side portion 56C will be described later) of the regular triangle are formed into a curved surface with a large radius of curvature which is curved outwards moderately convexly, and three apex portions (apex portions 55A, 55B, 55C, in which the apex portion 55B will be described later) of the regular triangle are formed into a curved surface with a small radius of curvature. A flat shoulder portion 51D is formed horizontally outwards of the male thread portion 51B of the body portion 51. An outer edge of the shoulder portion 51D is contoured into a substantially triangular shape (a rice ball shape) when viewed from above.

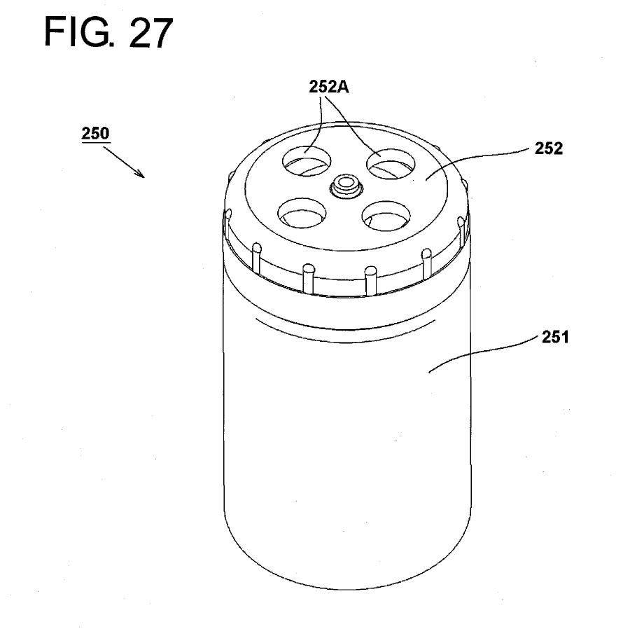

The shoulder portion 51D and the side portions 56A to 56C and the apex portions 55A to 55C are connected by a moderate curved surface with a small radius of curvature as viewed in a vertical section. This portion constitutes a connecting portion extending from the shoulder portion to the side portions and extending from the shoulder portion to the apex portions. The strength of the sample container at this portion is increased by forming the portion so as to have as small a radius of curvature as possible. Similarly, a bottom surface portion 51E and the side portions 56A to 56C and the apex portions 55A to 55C are connected by a moderate curved surface with a small radius of curvature as viewed in the vertical section. It can be understood from the perspective view in FIG. 3 that the non-cylindrical sample container 50 of the embodiment differs largely from the conventional cylindrical sample container 250 (FIG. 27). In the sample container 50, the cap portion 52 may have the same structure as that of the lid 252 of the conventional sample container 250. Consequently, in the event that the cap portion 52 have the same diameter as that of the lid 252 of the conventional sample container 250, the lid 252 can be used as the cap portion 52 with no modification made thereto. In the case of the same lid being used, since the body portion 51 is made far thicker than the body portion 251 in FIG. 27, it can be understood that the capacity of sample that can be contained therein is increased remarkably.

The body portion 51 and the cap portion 52 of the sample container 50 are preferably formed of a thermoplastic material such as polypropylene and polycarbonate, the body portion 51 can easily be formed by employing a blow molding process or an injection blow molding process. The cap portion 52 can easily be formed by employing an injection blow molding process. By using such a plastic material, there can be realized the sample container which has good chemical resistance and which is easy to be handled. In addition, rubber is suitable for a material of which the O-ring 57 is formed, and those commercially available can be used for the O-ring 57. The color of the body portion 51 may be transparent or colored so that the interior or contents cannot be seen from the outside.

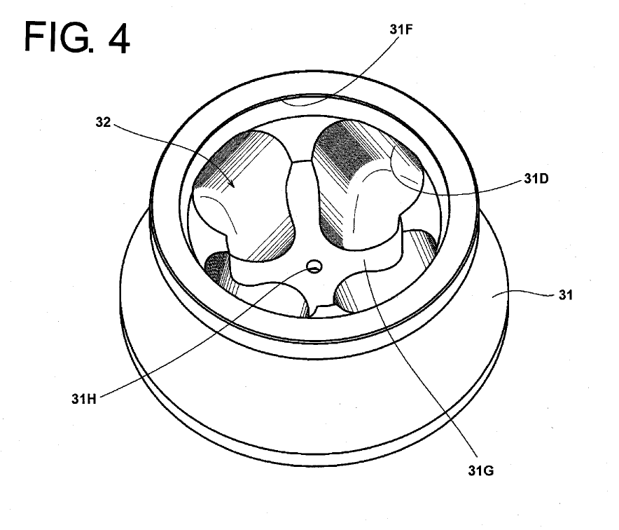

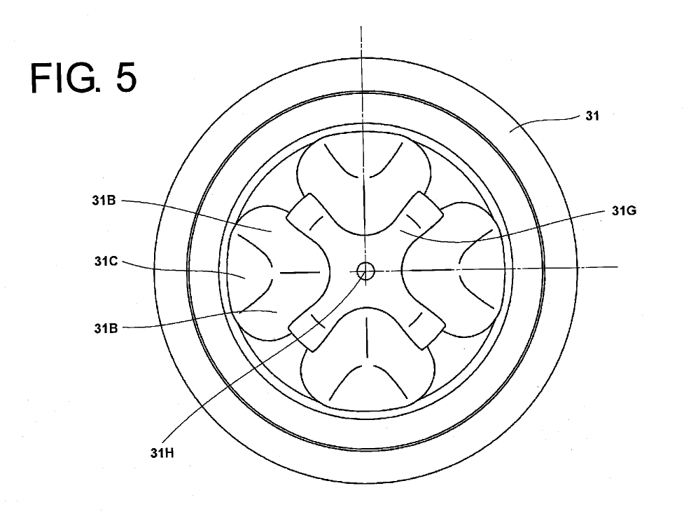

Next, the shape of the rotor body 31 will be described by use of FIGS. 4 and 5. FIG. 4 is a perspective view of the rotor body 31 according to the embodiment of the invention, and FIG. 5 is a top view of the rotor body 31. Four non-cylindrical holding holes 32 are provided in the rotor body 31 for attaching sample containers 50. The holding hole 32 has a shape which is substantially the same as an external shape of the sample container 50 and is preferably sized so that the sample container 50 can be attached therein with no difficulty and with as small a gap as possible formed therebetween. For example, a gap of approximately 0.1 to 1 mm is formed between a wall surface of the holding hole 32 and an outer surface of the body portion 51. In case this gap is too large, the degree of deformation of the sample container 50 due to a liquid pressure or centrifugal force exerted to the sample container 50 during centrifugal separation is increased, resulting that the durability of the sample container 50 may be reduced. The holding hole 32 is formed mainly by four surfaces, that is, a bottom portion 31C and two inner circumferential side wall portions 31B (with which two of the side portions of the sample container 50 are mainly brought into abutment) which are shown in FIG. 5 and an outer circumferential side wall portion 31D (with which two of the side portions of the sample container 50 are mainly brought into abutment) which is shown in FIG. 4. The outer circumferential side wall portion 31D is a curved surface with a large radius of curvature which corresponds to the sample container 50, and the holding hole 32 is formed so that the radius of curvature of the curved surface or the outer circumferential side wall portion 31D becomes substantially parallel to a radius of curvature of an outer circumference of the rotor body 31. By adopting this configuration, an unnecessary increase in thickness of the peripheral portion of the outer circumferential side wall portion 31D due to the difference in curvature can be suppressed, thereby making it possible to realize a reduction in weight of the rotor 30. The holding hole 32 is formed so as to cover almost all the surface portions and the bottom portion of the body portion 51 excluding a portion on the inner circumferential side as is shown in FIG. 3. By increasing the area to be covered in this way as much as possible, the deformation of the sample container 50 itself can be prevented during centrifugal separation.

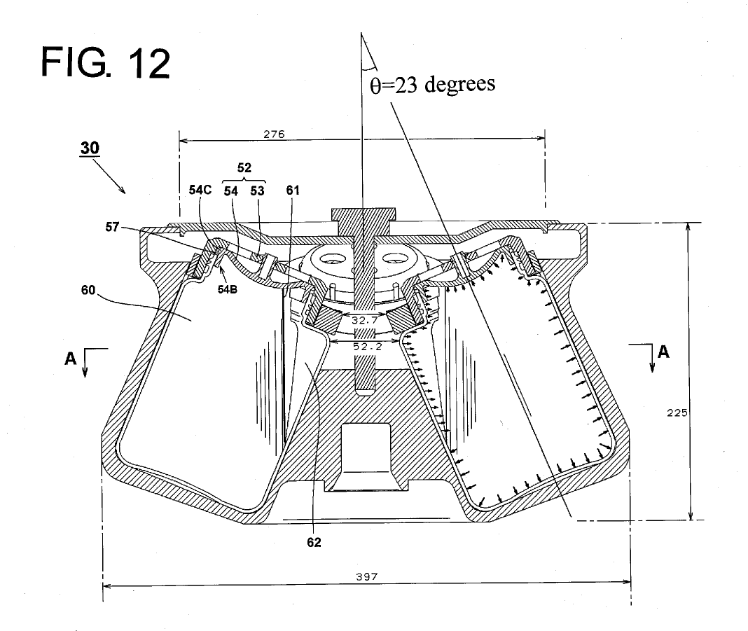

The weight of the rotor body 31 can be reduced owing to a reduction in volume of a metal portion by reducing the thickness around the holding hole 32 because size of the holding hole 32 increases as a result of the increase in capacity of the sample container 50. Further, in the rotor body 31 of this embodiment, a concave portion (thickness reduced portion) 31G is formed by reducing the thickness of a central portion so as to gouge the portion downwards. This is because a centrifugal load exerted on the sample container 50 in the vicinity of the central portion is directed radially outwards and hence the holding of the container on the inner circumferential side is not so important (this centrifugal load will be described later by reference to FIG. 12). The weight of the rotor body 31 at an axial upper portion can be reduced by forming the concave portion (thickness reduced portion) 31G in the way described above, thereby making it possible to realize a further reduction in weight of the rotor 30. In addition, by providing the concave portion (thickness reduced portion) 31G, the center of gravity of the rotor 30 can be lowered. A screw hole 31H is formed in the center of the rotor body 31 into which the handle 41 is screwed to fix the rotor cover 40.

The rotor body 31 is an integral structure (a solid structure) which is formed through machining by use of an aluminum alloy material or a titanium alloy material. In addition, the rotor body 31 can also be formed of a CFRP composite material. In machining the rotor body 31 from such a metallic material, a milling machine is used, and an end mill is used as a blade, whereby the rotor body 31 can easily be worked. External dimensions of the rotor body 31 are limited by the size of the chamber 3 (refer to FIG. 1), and therefore, in the event that the rotor body 31 is made in the same dimensions as those of the conventional one, the rotor 30 according to this embodiment can also be used in the conventional centrifuge.

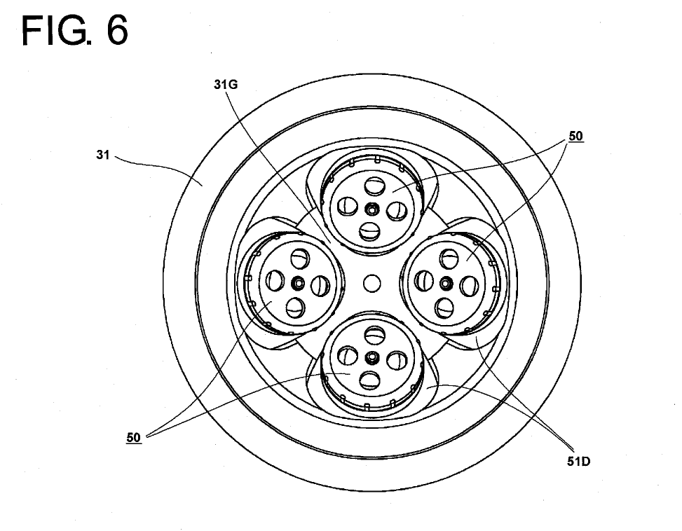

FIG. 6 is a top view of a state in which the sample containers 50 are attached in the rotor body 31. In FIG. 6, a condition is shown in which a neck support 70, which will be described later, is removed so as to clarify the installation of the sample containers 50. The rotor body 31 is a so-called angle rotor in which the holding hole 32 is angled at a predetermined angle so that the bottom portion 31C is spaced away from a vertical center line (an axis of a rotational shaft) of the rotor 30. The angle is preferably 20 degrees or larger and smaller than 25 degrees, and in this embodiment, the angle is 23 degrees. Because of this, as is shown in FIG. 6, the sample containers 50 are disposed so that upper surfaces of the cap portions 52 are inclined towards the rotational shaft. In addition, when the sample containers 50 are attached in the holding holes 32, it can be understood when viewed from above that the respective shoulder portions 51D of the sample containers 50 are exposed and outer circumferential sides of the cap portions 52 are not held by the outer circumferential side walls of the holding holes 32.

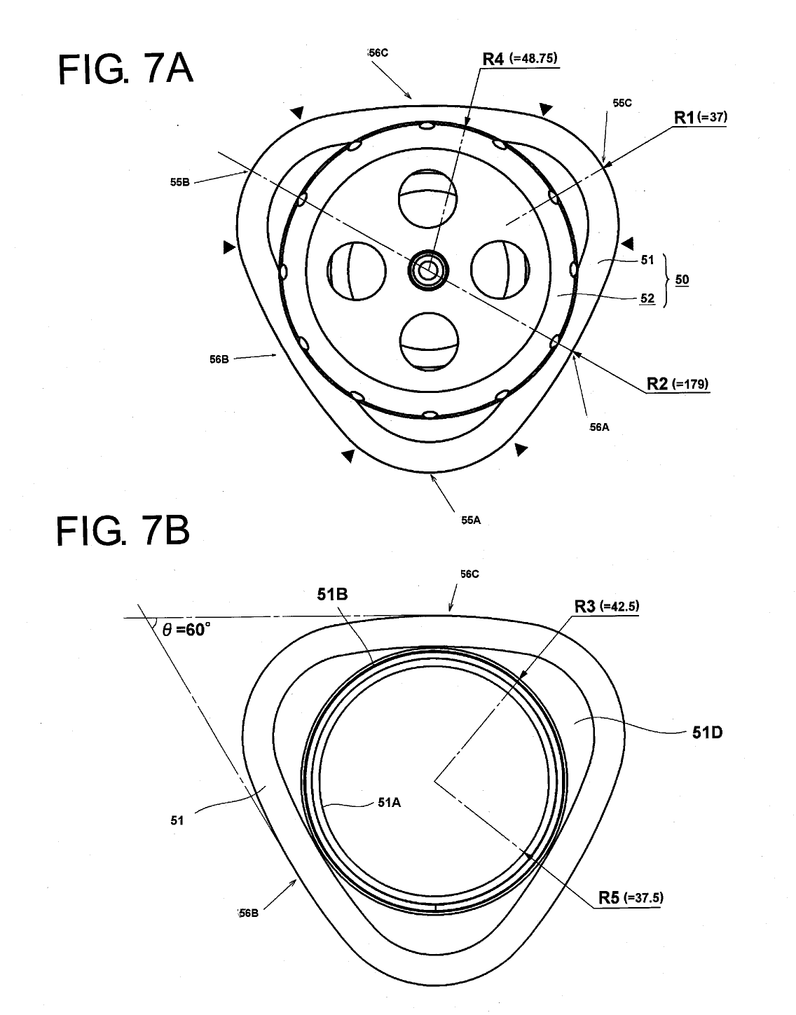

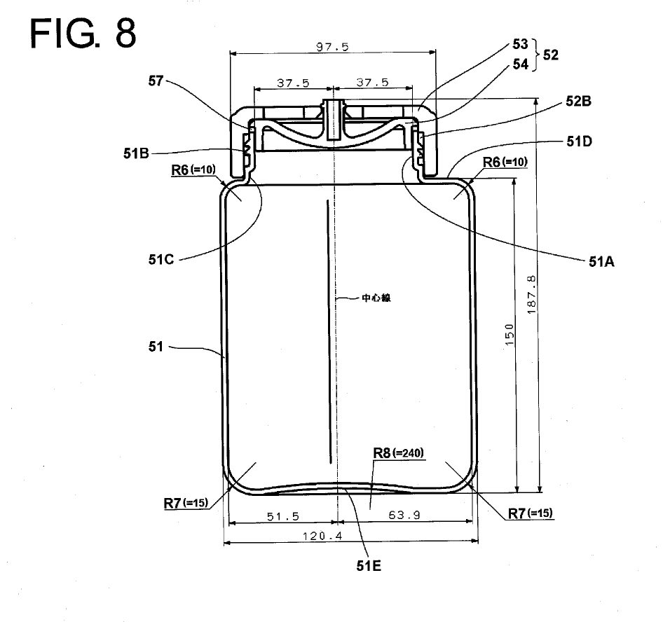

Next, dimensions of the sample container 50 will be described by use of FIGS. 7A, 7B and 8. FIGS. 7A and 7B show top views of the sample container 50, of which FIG. 7A shows a state in which the cap portion 52 is attached, and FIG. 7B shows a state in which the cap portion 52 is removed. Numerals shown within parentheses in the figures denote dimensions (in mm as unit) of radii of curvatures. In FIGS. 7A and 7B, the body portion 51 of the sample container 70 has the external shape based on the substantially regular triangle when viewed from above. An external position of the body portion 51 is located further outwards than an external position of the cap portion 52 and has the three apex portions 55A, 55B, 55C and the three side portions 56A, 56B, 56C. The apex portions 55A, 55B, 55C are formed not into a sharp corner but into a curve with a small radius of curvature R1. In addition, the side portions 56A, 56B, 56C are formed not into a straight line but into an arc-like shape with a large radius of curvature R2 which is curved convexly to an outer side of the sample container 50 when viewed from above.

When viewed from above, the sample container 50 is formed by the three curved surfaces with the radius of curvature R1 and the three curved surfaces with the radius of curvature R2. Connecting positions between the curved surfaces with the radius of curvature R1 and the curved surfaces with the radius of curvature R2 are indicated by triangular marks. In this way, the three sides (the side portions 56A, 56B, 56C) of the body portion 51 of the sample container 50 are formed by the large arc-shaped surfaces and the three apex portions 55A, 55B, 55C are formed into the small arc-shaped surfaces, whereby the sample container is made into the cylindrical container having the substantially regular triangular shape when it is seen from above or in cross section, thereby making it possible to realize a remarkable increase in capacity thereof. Although the three sides (the side portions 56A, 56B, 56C) of the sample container 50 may be formed not into the arc-like shape but into a straight line, by forming the three sides by the arc-shaped surfaces which swells outwards, the capacity of the sample container can be increased although slightly, and the resulting configuration becomes advantageous in terms of strength against inside pressure exerted from the sample contained in the interior thereof during the operation of the centrifuge.

In FIG. 7B, an intersection angle A formed by extensions of tangents to the side portions 56B, 56C which hold one of the apex portions therebetween is 60 degrees. In the figure, although intersection angles in relation to tangents to the side portions 56A, 56B and tangents to the side portions 56C, 56A are not shown, since the external shape of the body portion 51 is the substantially regular triangle, the intersection angles θ of these tangents are all 60 degrees. In addition, distances between centers of the apex portions 55A, 55B, 55C (positions indicated by arrows in FIG. 7A and center positions between the triangular marks) are equal to each other. A radius of the opening portion 51A formed in the upper portion of the body portion 51 is R5, and the male thread portion 51B is formed on the outer circumferential side of the opening portion 51A. A radius on the outer circumferential side of the male thread portion 51B is R3. In this way, the body portion 51 has the opening portion 51A which is sufficiently smaller than the external shape thereof, whereby the shoulder portion 51D is formed which extend from the opening portion 51A to reach the side portions 56A to 56C and the apex portions 55A to 55C. The shoulder portion 51D constitutes a horizontal plane when the sample container 50 is placed vertically. By the formation of the shoulder portion 51D, the strength of the body portion 51 can be increased further. In addition, by the provision of the shoulder portion 51D, the neck support member 70, which will be described later, is easily attached thereto.

FIG. 8 is a vertical sectional view of the sample container 50 according to the embodiment, and dimensions (in mm as unit) of the constituent portions are given. A portion in the vicinity of a joining point between a vertical portion of the body portion 51 and the shoulder portion 51D is formed into a moderate curved surface with a radius of curvature R6. At a lower portion of the body portion, a portion in the vicinity of a joining point between the bottom surface portion 51E and the vertical portion of the body portion 51 is formed into a moderate curved surface with a radius of curvature R7. Further, a portion in the vicinity of a center of the bottom surface portion 51E is formed into a slightly upwardly swelling shape, and a radius of curvature R8 thereof is of the order of 240 mm. By adopting this configuration, when the sample container 50 is placed vertically (placed in a condition shown in FIG. 8) on a table or the like, an area where a lower side of the bottom surface touches the table is reduced, whereby the sample container stays stable when it is placed in the way described above. In this disclosure, the context that the shape on a floor side is the substantially triangular shape does not mean the area of the contact portion with the floor side but the shape of the portion above the floor side, that is, the shape of the inner surface side of the body portion.

The commercially available cylindrical sample container 250 (refer to FIG. 27) have such dimensions that an outside diameter (a diameter) of the body portion 251 is 98 mm, the length of the body portion is 133 mm, and the capacity of sample that can be contained is 900 ml. In the event that only the dimension of R2 of the sample container 50 is changed so that the sample container 50 is circumscribed on to the outside diameter of the conventional cylindrical sample container 250 with the height of the container, the diameter of the opening portion and the sizes of the outer lid and the inner lid made to coincide with those of the sample container 250, an internal capacity of the sample container 50 is 1075 ml, and hence, the volume of sample that can be contained therein can be increased by 19.5% over that of the conventional sample container 250. A target volume of 1200 ml which is a 20% volume increase over the nominal capacity of 1000 ml of the conventional sample container can be achieved with a large margin by the volume increasing effect resulting from the substantially triangular shape and setting the dimension of R2 and the height of the container as shown in FIG. 8, and in this embodiment, a volume of about 1500 ml can be attained.

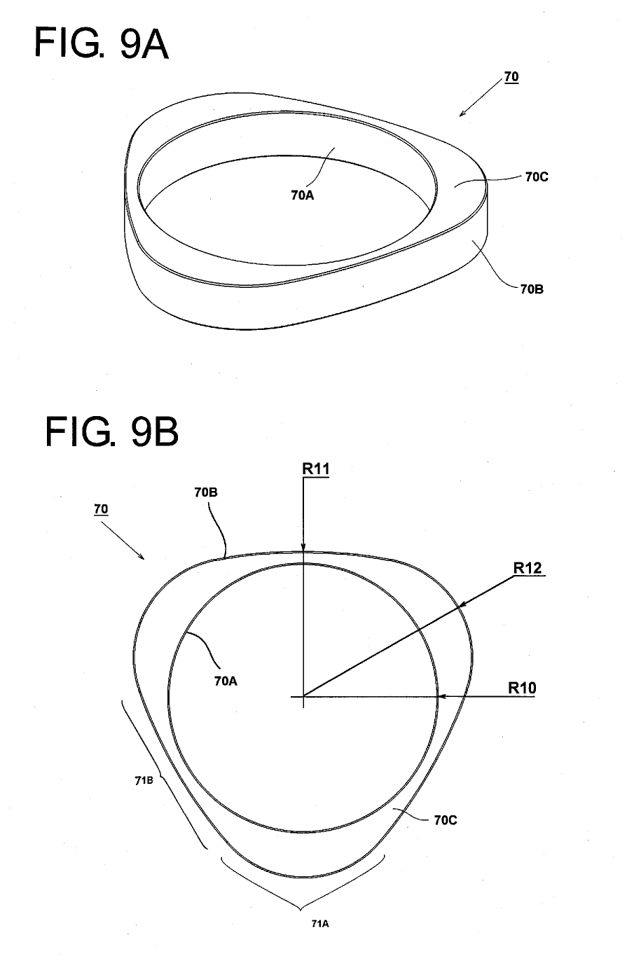

Next, the neck support member 70 will be described by use of FIGS. 9A and 9B. FIGS. 9A and 9B show diagrams depicting the shape of the neck support member 70 shown in FIG. 1, of which FIG. 9A shows a perspective view, and FIG. 9B shows a top view of the neck support member 70. As is shown in FIG. 1, the neck support member 70 is placed between the cap portion 52 of the sample container 50 and the holding hole 32 and functions to prevent the deformation of the cap portion 52 of the sample container 50 in the direction of acting centrifugal force.

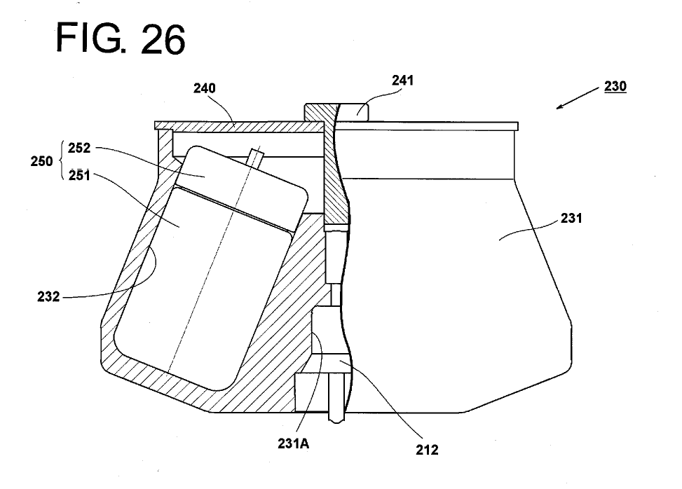

In the centrifuge, the rotor 30 rotates at high speeds. The outer circumferential portion of the cap portion 52 and the outer circumferential side wall portion 31D of the rotor body 31 is spaced apart from each other. Moreover, there is provided no portion to hold the outer circumferential side of the cap portion 52. Therefore, a portion lying in the vicinity of the opening portion 51A of the body portion 51 or the shoulder portion 51D may be damaged by the centrifugal load of the cap portion 52. In the case of the conventional cylindrical sample container 250 shown in FIG. 26, since the external shapes of the body portion 251 and the lid 252 are the same, the outer circumferential side of the lid 252 can be held by the wall surface of the holding hole 132, and hence, there can be produced no such situation that the body portion of the sample container is damaged. Then, in this embodiment, in order to support the outer circumferential portion of the cap portion 52, the neck support member 70 is provided which acts to fill the gap formed between the cap portion 52 and the holding hole 32.

The neck support member 70 is shaped so that an external shape fits to the holding hole 32 in the rotor body 31 and a gap between the holding hole 32 and itself is approximately 0.1 to 1 mm. In addition, a lid insertion hole 70A, which is larger by approximately 0.1 to 1 mm than an outside diameter of the cap portion 52, is formed inside the neck support member 70. The thickness of the neck support member 70 is arbitrary, provided that the thickness is good enough to detachably support the cap portion 52, and the neck support member 70 does not have to be the same thickness thereover. In this embodiment, in consideration of the strength of the cap portion 52, the thickness of the neck support portion 70 is approximately half or 50% of the height (the thickness) of the cap portion 52.

The neck support member 70 is used so as to be placed on the shoulder portion 51D to surround the cap portion 52 from above the sample container 50 after the sample container 50 is attached in the rotor body 31. The neck support member 70 only has to be placed on the sample container 50. The neck support member 70 can prevent the cap portion 52 from being deformed in the direction of acting centrifugal force during centrifugal separation by employing in the way described above. Similar to the material of the body portion 50, the neck support member 70 can be formed of a thermoplastic material such as polypropylene or polycarbonate and can be formed easily through an injection molding process. However, the neck support member 70 is formed of a non-elastic material.

The neck support member 70 can attain its original object in case the neck support member 70 holds only almost half (an outer side) the outer circumferential side of the cap portion 52. However, in this embodiment, due to ease of fabrication, the neck support member 70 has almost the same shape of that of the sample container 50 and is configured so as to have apex portions 71A and side portions 71B. By adopting this configuration, the neck support member 70 can be attached in the holding hole 32 in the rotor body 31 in three circumferential positions, and therefore, the attachment thereof is facilitated. Note that the shape of the neck support member 70 does not have to be limited to the shape shown in FIGS. 9A and 9B and hence can be modified variously.

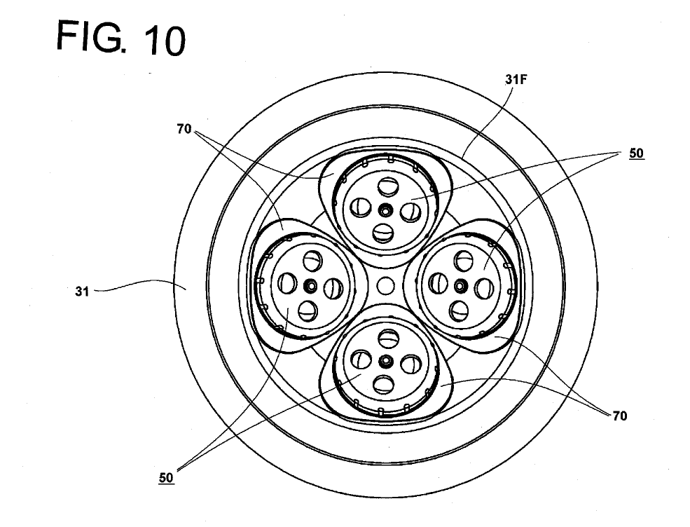

FIG. 10 is a top view showing a state in which the sample containers 50 and the neck support members 70 are attached in the rotor body 31. The holding holes 32 in the rotor body 31 are angled at a predetermined angle, and therefore, the sample containers 50 and the neck support members 70 are attached not vertically but in an inclined fashion through an angle equal to the angle at which the holding holes 32 are angled. After the neck support members 70 are attached in this way, the rotor cover 40 is placed over the rotor 30, starting a centrifugal separating operation.

Thus, in the embodiment, the cross-sectional shape of the sample container 50 is made non-circular so as to increase the capacity thereof, and therefore, the weight of the rotor 30 in which the sample containers 50 are installed is increased. However, when comparing the increased amount of samples to be contained in the sample containers 50 with the reduced volume of the rotor 30 in mass, the increase in diameter and mass of the rotor can be suppressed compared with the conventional rotor body 131 having the same diameter as that of the rotor body 31 of the embodiment. This is because the excess portions lying around the sample containers can be reduced while increasing the amount of samples to be contained and the increased volume of samples can be accommodated in the excess portions.

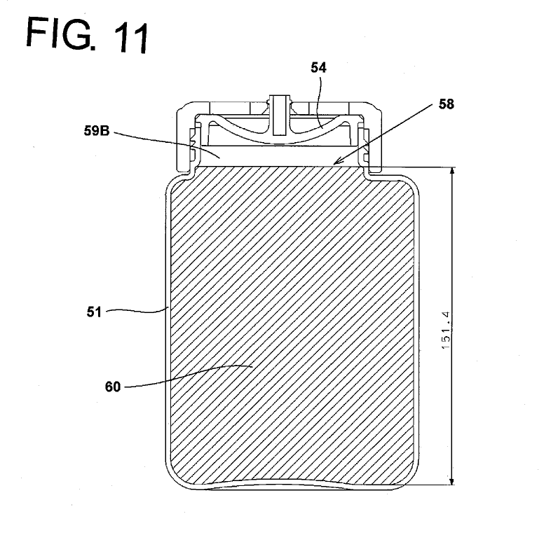

Next, a centrifugal separating condition in the centrifuge 1 of the embodiment will be described by use of FIGS. 11 to 15. FIG. 11 shows a state in which a sample 60 is poured up to an upper limit position 58 of the sample container 50. In the sample container of the embodiment, the volume of 1500 ml is filled up when the sample 60 is poured up to the upper limit position 58. Even in the event that the sample 60 is poured up to the upper limit position exactly, a space 59B is formed between the inner lid 54 and the upper limit position 58, and air is present in this portion. FIG. 12 shows a sectional view showing a state resulting when a centrifugal separating operation is performed in this state. FIG. 12 further depicts sizes of the constituent portions of the rotor 30 which contains the sample up to the volume of 1500 ml, the sizes being described in mm as unit. The diameter of the rotor body 31 is preferably 350 mm or larger and 450 mm or smaller. In this embodiment, the diameter of a thickest portion is 397 mm. The height of the rotor body 31 is preferably 200 mm or larger and 250 mm or smaller, and in this embodiment, the height of the rotor body 31 is 225 mm. In addition, the diameter of the opening portion of the rotor body 31 is 276 mm. The angle θ of the sample container 50 is 23 degrees. A distance between circumferentially innermost portions of the adjacent sample containers 50 is 52.2 mm, and a distance between circumferentially innermost portions of the adjacent neck support members 70 is 32.7 mm. The rotor 30 having this size is limited in admission into the chamber 3 (refer to FIG. 1) which is to accommodate the rotor 30, however, in the case of this embodiment, an inside diameter of the chamber 3 is 430 mm, and an internal maximum height is 276 mm.

When the rotor 30 rotates, the sample 60 is shifted to an outer circumferential side of the sample container 50 by virtue of centrifugal force as is shown in FIG. 12. The vertical sectional view of the rotor 30 shown in FIG. 12 shows a state of the rotor 30 which is rotating at a target rotational speed, and a liquid level 61 becomes vertical by the centrifugal force. In addition, air present in the interior of the sample container 50 is shifted, as a result of which a space 62 where air is present can be formed circumferentially inwards of the liquid level 61. When a centrifugal load is applied to the sample 60, pressures resulting from the centrifugal load which are indicated by a plurality of arrows in a right-hand side sample container are applied to portions of the sample container 50 due to liquid pressure. As this occurs, a skirt portion 54B of the inner lid 54 is deformed outer circumferentially by a centrifugal load thereof and the pressures, whereby the skirt portion 54B can be secured closely and strongly to an inner surface of the opening portion 51A of the body portion 51. In addition, a collar portion 54C formed on part of the inner lid 54 and the outer lid 53 are deformed so as to press the O-ring 57 against the body portion 51 side by the centrifugal load applied thereto. Therefore, the O-ring 57 is closely secured to the inner lid 54 and the opening portion 51A of the sample container, whereby there is caused no such situation that the sample 60 leaks to the outside from the cap portion 52.

A force is applied to the outer circumferential side of the sample container 50 so that the liquid is pushed out to an outside of the container. On the other hand, in the space 62, a load is applied in a direction in which the wall portion of the sample container 50 is pushed out to the outside by the centrifugal force. Normally, when the centrifugal load applied to the wall portion of the sample container 50 is increased, the sample container 50 fails in the worst case. In this embodiment, however, the portion of the sample container 50 to which the centrifugal load is applied is an inner circumferential side portion which is located in the vicinity of the apex portion, and this apex portion is made up of the curved surface with the small radius of curvature R1. Thus, at the apex portion, the rigidity is high and no edge is present and hence, no stress concentration occurs thereat, and the apex portion is has a strong resistance against centrifugal load. In addition, the opening portion 51A of the sample container 50 is circular and is, moreover, drawn inwards for attachment of the cap portion 52, and the shoulder portion 51D is formed. Consequently, in the sample container 50 of this embodiment, the rigidity of the portion where the space 62 which is the portion where load is particularly applied is present is increased to the high level. Therefore, the strength of the sample container 50 can be increased while increasing the capacity thereof, as a result of which the sample container 50 which has superior durability can be realized.

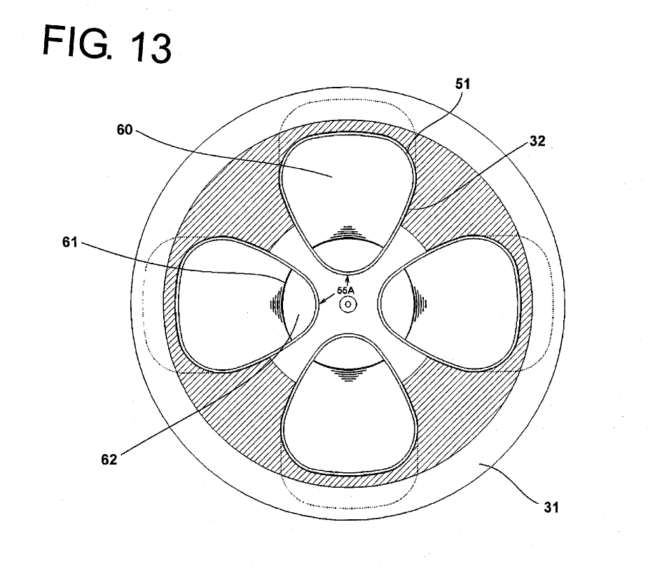

FIG. 13 is a sectional view taken along the portion indicated by arrows A, A in FIG. 12. As can be understood in FIG. 13, the liquid level 61 is produced in a position shown in the figure, and the space 62 can be produced circumferentially inwards of the liquid lever 61. Consequently, a force which acts on the apex portion 55A due to the liquid pressure produced by the centrifugal force to swell the apex portion 55A is not exerted on the apex portion 55A which is located in the position of the space 62 within in the body portion 51 of the sample container 50. Therefore, a force (a load) which deforms the apex portion 55A towards the inner side of the body portion 51 is applied. Because of this, the apex portion 55A which is located in the position of the space 62 bears the centrifugal load only by the rigidity thereof. The radius of curvature of this apex portion is smaller than the radius of curvature of the conventional cylindrical sample container 250 even when viewed in the cross section, and therefore, the strength of the sample container 50 thereat is remarkably higher that that of the conventional sample container 250. Further, the apex portions 55 are formed by the curved surfaces with the radius of curvature R1 (semi-circular), whereby no edges are produced, thereby preventing the occurrence of stress concentration.

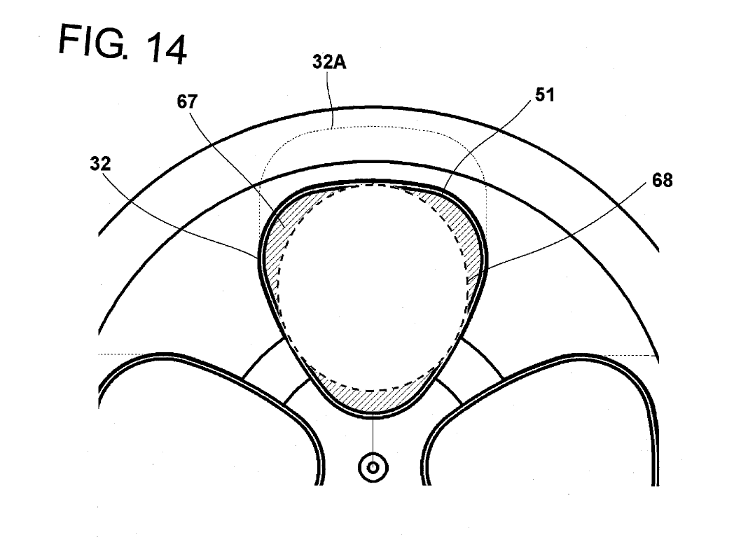

FIG. 14 is a diagram showing a positional relationship between the shape of the body portion 51 of the sample container 50 according to the embodiment and a shape 68 of the body portion 251 of the conventional cylindrical sample container 250 for comparison. An outer contour of the bottom portion of the holding hole 32 is indicated by a thin dotted line 32A. In addition, the shape 68 is indicated by a thick, relatively widely spaced dotted line. The cross-sectional shape of the body portion 51 (however, since the cross-sectional shape is the section taken along the portion indicated by the arrows A, A in FIG. 12, the section is not a section which is normal to the center line 35 (refer to FIG. 2) of the sample container 50 but is a section which is normal to the rotational shaft of the rotor 30) is substantially triangular. The oval shape 68 which is indicated by the dotted line is the shape of the conventional cylindrical sample container. Shaded portions between the shape 68 of the conventional body portion 251 and the sample container 50 indicate the increased amount of sample, and these portions constitute excess spaces 67 when the sample container 50 is formed of a metallic material. In addition, the excess spaces 67 also represent areas corresponding to the amount of reduced mass of the holding hole 32 in the rotor body 31. By forming the sample container 50 and the holding hole 32 into the substantially triangular shapes, the excess spaces 67 can be cut out which constitute the portions which act as excess portions to increase the mass of the rotor itself, as well as the centrifugal load applied to the rotor itself when the conventional cylindrical sample container 250 is used. As a result of this, the volume of sample to be processed can be increased without increasing the diameter of the rotor body 31, and on the other hand, the mass of the rotor 30 can be reduced.

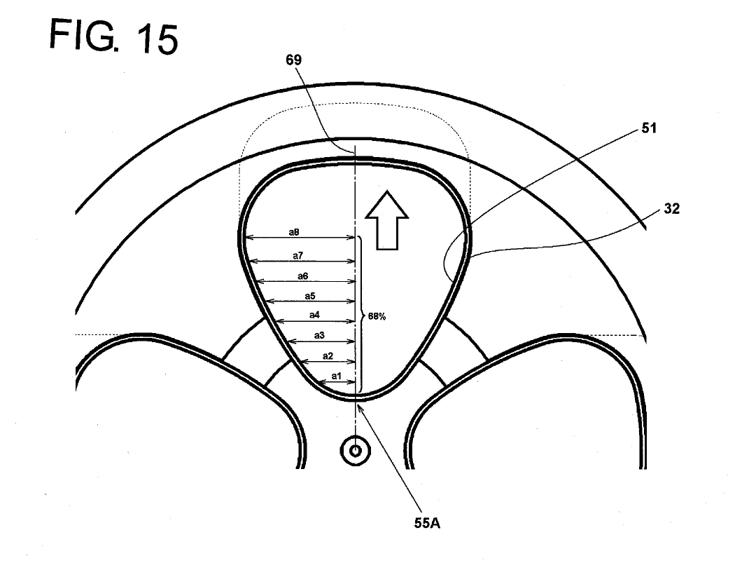

Next, a relationship between the shape of the horizontal section (the section taken along the portion indicated by the arrows A, A in FIG. 12) of the holding hole 32 and the direction in which centrifugal force is applied will be described by use of FIG. 15. In drawing an imaginary line 69 which passes through the center of the apex portion 55A on the inner circumferential side of the body portion 51 which is accommodated in the holding hole 32 and a center hole of the rotor body 31, when looking at distances to the inner wall of the body portion 51 normally to the imaginary line 69, that is, lateral widths a1 to a8, the widths increase gradually from a circumferentially innermost point towards the outer circumferential side. When looking at the lateral widths based on the imaginary line 69, the widths continue to increase from the inner circumferential side to a position lying half or more the distance to the outer circumferential side, or in the embodiment, a position lying 68% the distance to the outer circumferential side, which is more than two thirds the same distance. The sample container 50 which expands laterally as it extends in the direction of acting centrifugal force in the way described above is useful in performing an efficient and highly accurate centrifugal separation. Namely, there is caused almost no such situation that particles move along the wall of the container, and therefore, particles can move smoothly. Thus, the centrifugal separation time can be reduced, and further, a band of particles having the same specific gravity can be produced neatly within a short period of time.

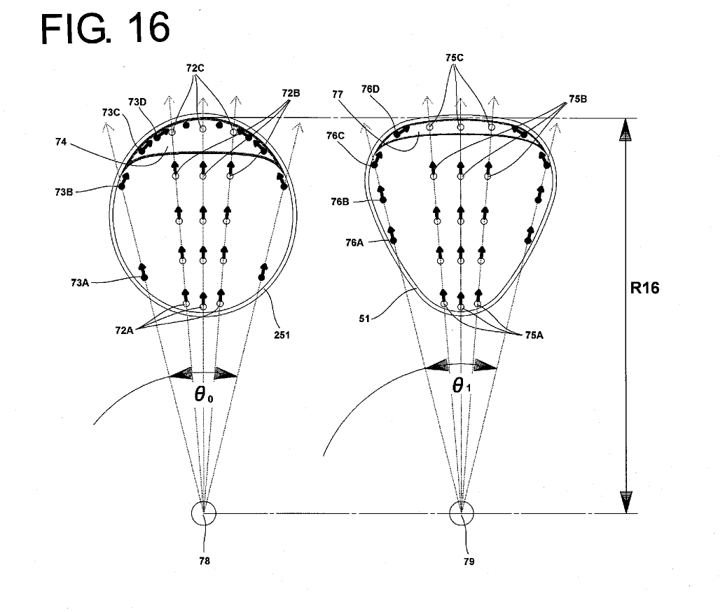

FIG. 16 depicts this state more clearly. FIG. 16 is an exemplary diagram showing centrifugal separation conditions by the sample container 50 and the conventional sample container 250 which is circular in section. In the figure, particles are exemplarily drawn larger for the sake of easy understanding of the disclosure. In addition, the sizes of the rotors (in relation to a radius R16 in the figure) are depicted the same, and θ₀ and θ₁ are depicted at the same angle. A left-hand side oval cross section depicts the cross section of the body portion 251 of the sample container 250, and a right-hand side substantially triangular cross section depicts the cross section of the body portion 51 of the sample container 50 according to the embodiment. In the centrifugal separating operation, particles present in the body portions 251, 51 of the sample containers move towards the outer circumferential side by the centrifugal force produced in association with the rotation of the rotor. A point 78 denotes the position of a rotation center of the sample container 250, and a point 79 denotes the position of a rotation center of the sample container 50. The point 79 coincides with the position of the screw hole 31H shown in FIGS. 4 and 5.

In the conventional sample container shown on the left-hand side, particles 72A which are positioned on an inner circumferential side of the sample container 250 move towards an outer circumferential side as the rotor rotates, pass through a position where particles 72B are present and then move to the outer circumferential side of the sample container 250 where particles 72C are present. On the other hand, a particle 73A positioned in the vicinity of a circumferential side surface of the sample container 250 similarly moves to a position where a particle 73B is present, collides against the wall of the sample container 250 and then moves as a particle 73C and a particle 73D do along the wall. In this way, the highly dense (heavy) particles contained in the sample move to the outer circumferential side to thereby be accumulated as a pellet 74.

In the sample container according to the embodiment shown on the right-hand side, particles 75A which are positioned on an inner circumferential side of the sample container 50 move towards an outer circumferential side as the rotor rotates, pass through a position where particles 75B are present and then move to the outer circumferential side of the sample container 50 where particles 75C are present. On the other hand, a particle 76A which is positioned in the vicinity of a circumferential side surface of the sample container 50 similarly moves to positions where particles 76B, 76C are present, respectively, collides against the wall of the sample container 50 and then moves along the wall as shown by a particle 76D. In this way, the highly dense (heavy) particles contained in the sample move to the outer circumferential side to thereby be accumulated as a pellet 77.

When both the sample containers are compared with each other here, the conventional sample container 250 has the circular wall, and therefore, the particles are collected to the center along the wall at the positions 73B to 73D. Thus, the particles have difficulty in moving due to friction with the wall, and hence the centrifugal separation needs to be carried out for a long period of time. On the other hand, when the sample container 50 is formed in the substantially triangular shape according to the embodiment, the degree at which the particle 76C collides against the wall is remarkably reduced. Even when there are particles which move along the wall, a distance over which the particles move along the wall is reduced, and therefore, the centrifugal separation may only have to be carried out for a short period of time. Thus, when the same samples are subjected to centrifugal separation, a good centrifugal separation effect is provided.

In many cases, the sample container 50 is caused to lie horizontally for removal of the pellet 77 settled in the container after the centrifugal operation has been completed. FIG. 16 shows a state in which the cap portion 52 of the sample container 50 of the embodiment is removed and the body portion 51 is placed horizontally on a resting surface 65. Although the pellet 77 settled is not shown, when the sample container 50 is placed horizontally, the same container is so placed with the side portion where the pellet 77 is accumulated placed downwards. As this occurs, since the cross-sectional shape of the body portion 51 is the substantially triangular shape, the sample container 50 does not roll, and therefore, the operator can handle the sample container 50 in a stable fashion, thereby making it possible to provide good operability. In particular, also when the pellet is scraped out to be transferred to another container, the scraping operation becomes easy to be performed with the sample container 50 placed horizontally, which is advantageous. In order for the sample container 50 to be prevented from rolling, the radius of curvature R2 of the side portions 56A, 56B, 56C are preferably set to be 170 mm or larger.

Thus, as has been described heretofore, a large volume of sample can be processed at one time by use of the rotor 30 and the sample container 50 according to the embodiment. In addition, the sample container 50 of the embodiment is constructed so that the width increases from the inner circumferential side towards the outer circumferential side, and therefore, particles lying in the vicinity of the wall are allowed to reach the wall only after moving over a shorter distance. Thus, the possibility of the particles being influenced by the friction produced when they move along the wall surface can be reduced. Further, the external shape of the body portion 51 of the sample container 50 is not circular but substantially triangular, and therefore, there can be provided an advantage that the cap portion 52 is easy to be rotated when the operator attempts to rotate the cap portion 52 by one hand while gripping the body portion 51 by the other hand. In particular, after the centrifugal separating work has is completed, the rotor chamber 4 is cooled and hence the sample is also cooled in many cases, and hence, there may be caused such a situation that water collects as droplets on the sample container 50 removed. However, even in the event that the sample container 50 is wet, it is advantageous that the body portion 51 is made easy to be gripped by the three apex portions 55A, 55B, 55C.

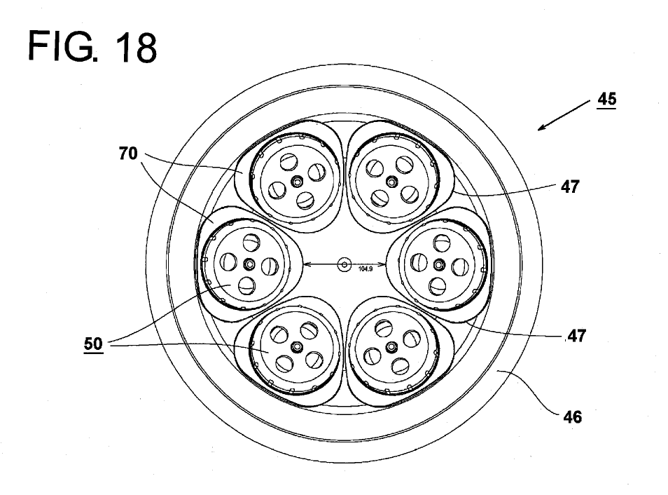

The shape of the rotor which accommodates the sample container 50 according to the embodiment is not limited to the shape described above, and hence, other shapes can be adopted. FIG. 18 shows a rotor 45 in which six holding holes 47 are formed with intervals therebetween reduced so that six sample containers 50 can be attached in the rotor 45. By adopting this configuration, the intervals between the adjacent holding holes 47 are reduced further, and wasteful space can be reduced. It is preferable that the attaching angle of the sample containers 50 according to the modified example is made smaller than that described in FIG. 12 and the angle may be in the range of 15 degrees or larger and smaller than 20 degrees. In this modified example, the angle is set to 17 degrees so that the sample containers 50 are attached so as to be placed slightly further vertical to thereby prevent the interference with the adjacent sample containers 50 when attached or detached. As a result of this, in the case of a diameter of a thickest portion of the rotor 45 being 431 mm, a distance between circumferentially innermost portions of neck support members 70 which face each other becomes of the order of 104.9 mm as is shown in the figure. In this way, according to the modified example, six sample containers 50 each having the volume of 1500 ml are attached in one rotor 45, and therefore, the sample of as much as 9 liters can be subjected to centrifugal separation in a single centrifugal separating operation.

### Second Embodiment

Next, a sample container 80 according to a second embodiment will be described. Although in the first embodiment the neck support members 70 which are the auxiliary members are used when the centrifugal separation is carried out, the neck support member 70 is the part which is prepared separately from the cap portion 52 and the body portion 51. Thus, there may be a possibility that the operator fails to mount the neck support members 70 and starts the operation of the centrifuge 1. Then, in the second embodiment, a cap portion and a neck support member are integrated with each other so that the failure to mount the neck support members 70 is prevented from occurring. As this occurs, however, when a screw type fastening approach is adopted in fastening a substantially triangular cap portion and a substantially triangular sample container together, a case can occur where there is caused a shift in position between a body portion of the sample container and the substantially triangular cap portion, and the substantially triangular external shapes of the cap portion and the body portion of the sample container do not match properly, resulting in a situation in which the sample container cannot be inserted into the holding hole in the rotor. In the event that the operator unscrews slightly the cap portion without any deep consideration to correct the matching error, there may be caused a risk that the sample leaks during centrifugal separation. Then, in the second embodiment, the cap portion is not screwed a single full rotation but is screwed less than the single full rotation, preferably, less than one third the single full rotation to be attached to the body portion of the sample container.

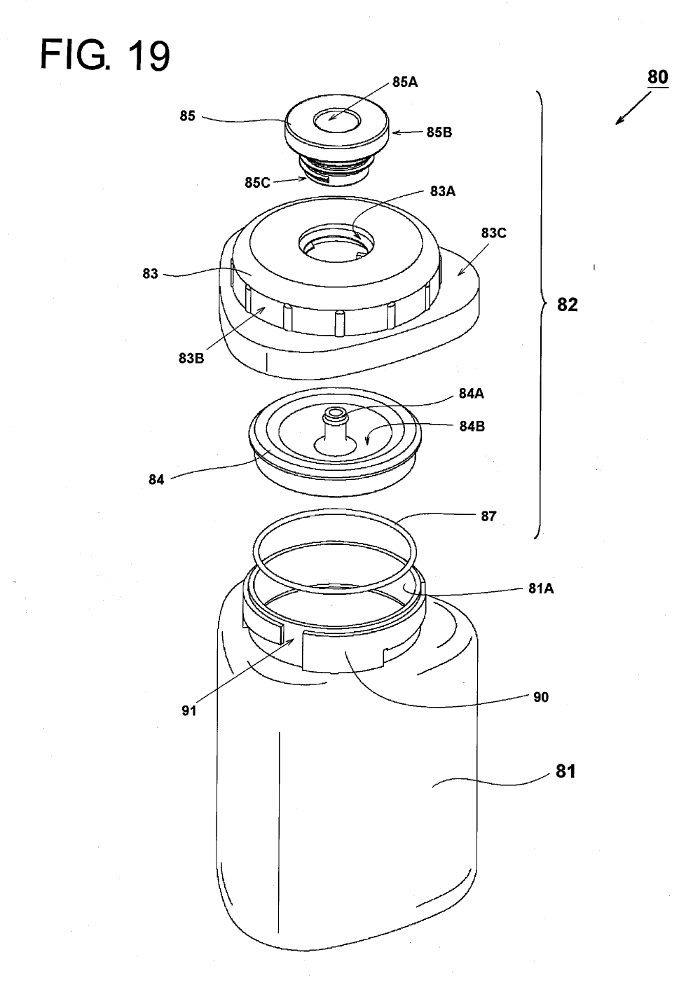

FIG. 19 is a perspective view showing an external appearance of a sample container 80 and shows a state in which a cap portion is disassembled. The sample container 80 is divided into a body portion 81 and a cap portion 82. The body portion 81 is a portion of the container where a liquid sample to be subjected to centrifugal separation is contained. A circular opening portion 81A for putting in and taking out the sample is provided in an upper portion of the body portion 81, and the cap portion 82 is attached to the opening portion 81A. The cap portion 82 is made up of an outer lid 83, an inner lid 84, a push piece 85, and an O-ring 87. An L-shaped groove portion 91 is formed in an outer circumferential surface of the opening portion 81A, and this L-shaped groove portion 91 constitutes an engaging unit. An engaging unit (which will be described later) is provided on an inner surface of the outer lid 83 and this engaging unit is paired with the engaging unit of the opening portion 81A. L-shaped groove portions 91 are provided at equal intervals in a circumferential direction at a plurality of locations, preferably, at three locations at angular intervals of 120 degrees, whereby the attachment of the cap portion 82 to the body portion 81 can be effected in a one-touch fashion. Namely, the cap portion 82 is placed axially downwards on to the body portion 81 and is then rotated until the engaging unit come into contact with terminating positions of the groove portions 91, whereby the cap portion 82 is fixed to the body portion 81. Following this, the push piece 85 which is removed or unscrewed is screwed into the outer lid 83, whereby the inner lid 84 is firmly secured to the opening portion 81A, and the sample container 80 is closed completely. The O-ring 87 is interposed between the cap portion 82 and the opening portion 81A of the body portion 81 so as to establish a sealed condition therebetween, and the inner lid 84 is attached to the body portion 81 via the O-ring 87. Then, the outer lid 83 is provided so as to cover them.

A cylindrical portion (which will be described later) is formed on a lower side of the outer lid 83 so as to correspond to the opening portion 81A of the body portion 81, and projecting portions (which will be described later) which make up the engaging unit are provided on an inner wall of the cylindrical portion. A female thread 83A is provided in a central portion of an upper surface of the outer lid 83 into which the push piece 85 is screwed. A hole 85A, which penetrates the push piece 85 in an axial direction, is provided to extend upwards from a lower surface of the push piece 85, and a projecting portion 84A on the inner lid 84 is accommodated in the hole 85A. An external shape of the push piece 85 is such that a grip portion 85B is formed on an outer circumferential portion of the push piece 85 so that the operator can screw it into the outer lid 83 with operator's hand. After the push piece 85 is attached to the outer lid 83, the projecting portion 84A of the inner lid 84 functions as a grip portion for attaching or removing the body portion 81 and the inner lid 84 to or from the body portion 81. When the push piece 85 is screwed in, a lower surface 85C of the push piece 85 presses down an upper surface 84B of the inner lid 84, and the O-ring 87, functioning as a sealing member between the body portion 81 and the inner lid 84, is compressed to thereby ensure a sealing performance of sample liquid. Incidentally, in place of the push piece 85 being shaped so that the grip portion 85B is formed so as project upwards largely from the outer lid, the push piece 85 may be shaped such that the push piece 85 does not project from the outer lid 83 so that the push piece 85 is screwed by using a tool.

The body portion 81 of the sample container 80 is made into a container having a cross-sectional shape (a shape resulting when viewed from above) based on a regular triangle in which side portions of the regular triangle are each formed into a curved surface with a large radius of curvature which is curved outwards moderately convexly and three apex portions of the regular triangle are each formed into a curved surface with a small radius of curvature. The shape and material of the body portion 81 of the sample container 80 are the same as those of the body portion 51 of the first embodiment excluding the shape of the engaging unit which include thick portions 90 and the groove portions 91, and hence, the repetition of the same description will be omitted here.

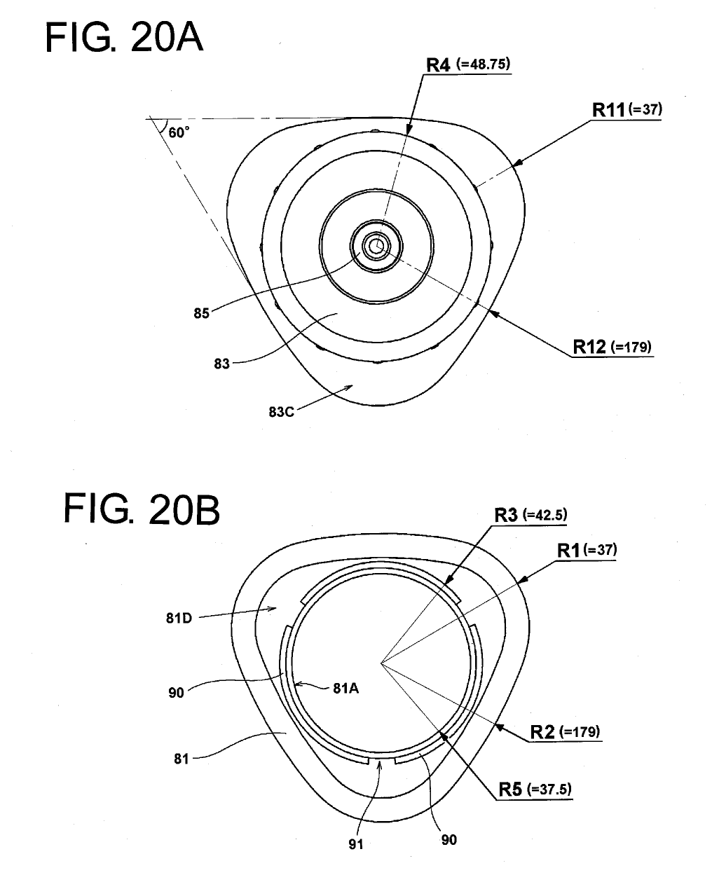

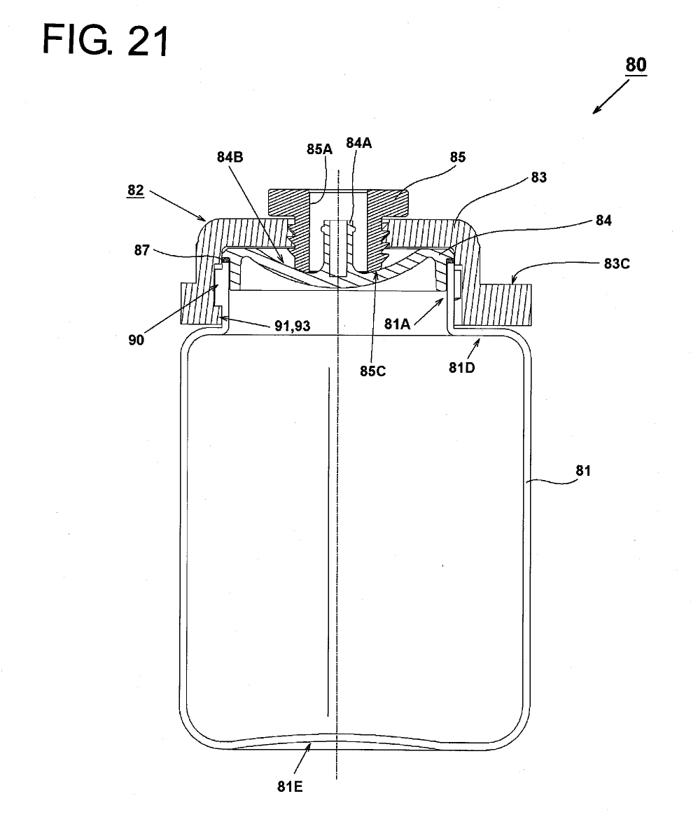

Next, the sample container 80 and the cap portion 82 will be described by reference to FIGS. 20A, 20B and 21. FIGS. 20A and 20B show top views of the sample container 80, of which FIG. 20A shows a state in which the cap portion 82 is attached, and FIG. 20B shows a state in which the cap portion 82 is removed. The external shape of the body portion 81 of the sample container 80 is the shape formed based on the substantially regular triangle when viewed from above. The external shape of the outer lid 83 of the cap portion 82 is formed based on a substantially triangular shape and in the same dimensions as the external shape of the body portion 81. In FIG. 20A, a radius of curvature R11 of an apex portion and a radius of curvature R12 of a side portion of a neck support portion 83C are absolutely the same as the radius of curvature R1 of the apex portion and the radius of curvature R2 of the side portion of the body portion 81 shown in FIG. 20B. Consequently, as is shown in FIG. 20A, when the sample container 80 is seen from above, the body portion 81 is invisible.

In FIG. 20B, an inside radius of the opening portion 81A is 37.5 mm and is absolutely the same as that of the body portion 51 of the first embodiment. Although an outside radius of the opening portion 81A at the thick portions 90 is 42.5 mm, this thickness may be set as required, and therefore, the outside dimension of the opening portion 81A does not have to coincide with the dimension of that of the body portion 51. When the outer lid 83 is rotated until the outer lid 83 is engaged with the opening portion 81A of the sample container so as not to be rotated any further, the substantially triangular external shape of the body portion 81 and the substantially triangular external shape of the neck support portion 83C coincide with each other when viewed from above, and the apex portions of both the members also coincide with each other. When this state is obtained, the external shape of the sample container coincides with the shape of the shape of the holding hole in the rotor, and therefore, the sample container 80 can be attached in the holding hole in the rotor. On the contrary, the sample container 80 cannot be attached in the rotor unless the cap portion 82 of the sample container 80 is tightened firmly, thereby making it possible to eliminate possibility that the centrifugal separation is started in such a state that the cap portion 82 is not tightened properly.

FIG. 21 is a vertical sectional view of the sample container 80 according to this embodiment. Dimensions (in mm as unit) of the constituent portions are the same as those of the sample container 50 of the first embodiment. Thus, the repetition of the same description will be omitted here. A portion lying in the vicinity of a joining point between a vertical portion and a shoulder portion 81D of the body portion 81 is formed into a moderate curved surface. Further, at a lower portion of the body portion, a portion lying in the vicinity of a joining point between a bottom surface portion 81E and the vertical portion of the body portion 81 is formed into moderate curved surface. Further, a portion of the bottom surface portion 81E which lies in the vicinity of a central portion thereof is formed into a slightly upwardly swelling shape. In this embodiment, the context that the shape on a floor side is the substantially triangular shape does not mean the area of the contact portion with the floor side but the shape of the portion above the floor side, that is, the shape of the inner surface side of the body portion. In this embodiment, the contact portion with the floor side constitutes an annular area. In this figure, the inner lid 84 is pressed downwards by the lower surface 85C of the push piece 85 from above the outer lid 83, and therefore, the O-ring 87 is compressed. In addition, in this state, an upper surface of an inner circumferential portion of the outer lid 83 is not in contact with the inner lid 84. Therefore, it can be understood that the inner lid 84 is pressed against the body portion 81 sufficiently.

The thick portions 90 are formed on the outer circumferential side of the opening portion 81A of the body portion 81, and portions where the thick portions 90 are not formed constitute the groove portions 91. On the other hand, the projecting portions 93 are formed at portions on an inner circumferential wall of the cylindrical shape of the outer lid 83, and the outer lid 83 is fixed in such a state that the projecting portions 93 enter the groove portions 91. Consequently, the thick portions 90 are located axially above the projecting portions 93. As this occurs, the O-ring 87 and the inner lid 84 are interposed between the opening portion 81A and the outer lid 83, and an upper surface 84B of the inner lid 84 is pressed downwards by the lower surface 85C of the push piece 85, whereby a good sealing performance can be obtained. To remove the cap portion 82 after the centrifugal separation is completed, firstly, the push piece 85 is unscrewed, and the lower surface 85C is shifted upwards so as to release the state in which the push piece 85 is pressed against the inner lid 84. Thereafter, the outer lid 83 is rotated. By following these steps, the outer lid 83 can be rotated smoothly, whereby the operator can easily remove the outer lid 83 by one hand. Thereafter, the operator grips on the projecting portion 84A to remove the inner lid 84.

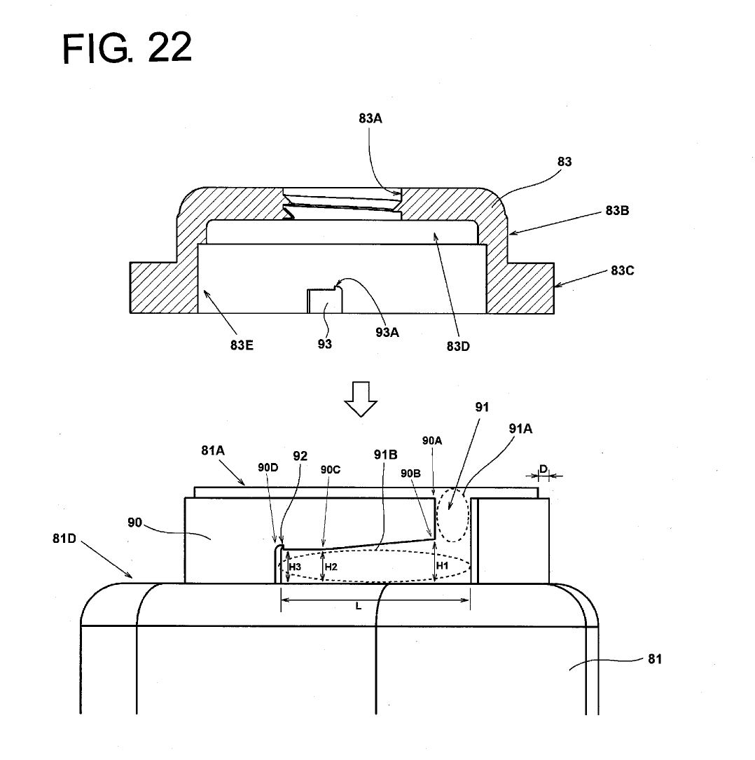

FIG. 22 shows a sectional view of the outer lid 83 so removed and a partial side view of a portion of the body portion 81 which lies in the vicinity of the opening portion 81A. The groove portion 91 having substantially L-shape when viewed from the side is formed above the body portion 81 and in the vicinity of the opening portion 81A. The groove portion 91 extends axially downwards from a groove entrance 90A, and the extending direction of the groove portion is changed through about 90° at a bent portion 90B to extend as far as a groove terminating end 90D. A depth (a radial thickness) of the groove portion 91 is set based on a thickness D at the thick portion. As a result of this, the groove portion 91 is made up of an axial groove (an area substantially indicated by a dotted line 91A) which extends from the opening portion 81A in a longitudinal direction (a up-and-down direction) and a circumferential groove (an area substantially indicated by a dotted line 91B) which extends about 45 degrees in a circumferential angle in a circumferential direction from a position lying in the vicinity of a lower end of the axial groove. A length L of the circumferential groove is a length of the order of about 60 degrees in the angle of the opening portion 81A. In addition, a vertical height of the circumferential groove is H1 in the vicinity of the bent portion 90B, H2 at a deformed portion 90C and H3 substantially just before a recess 92, and these heights are in a relationship of H1>H2≧H3. Since the circumferential groove is formed inclined so that the height is reduced gradually from the bent portion 90B to the deformed portion 90C, the axial pressing effect can also be expected when the cap portion 82 is turned. The recess 92 slightly recessed upwardly in the axial direction is formed in the vicinity of the groove terminating end 90D of the circumferential groove.

On the other hand, a cylindrical inner wall 83E is formed in the outer lid 83, and a space 83D is formed above the inner circumferential wall 83E for accommodation of the O-ring 87 and an upper projecting portion of the inner lid 84. The projecting portions 93 are formed at three circumferential portions on the inner circumferential wall 83E (note that the projecting portion 93 shown in FIG. 22 is a projection on a far side of the inner circumferential wall 83E, whereas the groove portion 91 shown is a groove on a near side of the opening portion 81A, and therefore, the projecting portion 93 and the groove portion 91 are not engaged with each other). A stopper projection 93A, which projects axially upwards, is provided at a portion of the projecting portion 93. When the stopper projection 93A is brought into engagement with the recess 92, the outer lid 83 is held stably so as not to easily be unscrewed or loosened.

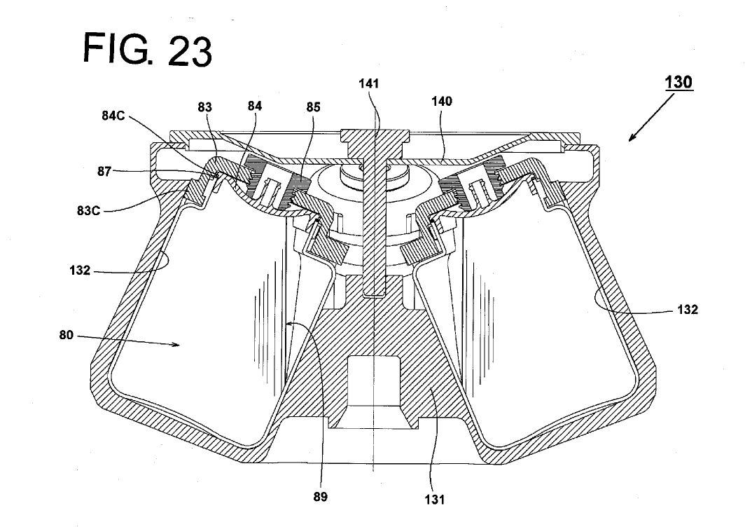

FIG. 23 is a sectional view of a rotor 130 in which the sample containers 80 are attached. The shape of the rotor 130 is almost the same as that of the rotor 30 shown in FIG. 2. A diameter of the rotor 130 at a thickest portion is 397 mm and a height thereof is 225 mm. In addition, an angle of the sample container 80 is 23 degrees. When the rotor 130 is rotating, as is shown in FIG. 23, a sample is shifted to an outer circumferential side of the sample container 80 by virtue of a centrifugal force produced, a liquid level 89 of the sample is oriented vertical. When a centrifugal load is applied to the sample, pressures are applied to various portions of the sample container 80 due to the liquid pressure of the sample. As this occurs, the inner lid 84 is deformed in an outer circumferential direction by its own centrifugal load and the pressure produced by the liquid pressure, and therefore, the inner lid 84 can be strongly secured tight to an inner surface of the opening portion 81A of the body portion 81. Additionally, a collar portion 84C formed partially on the inner lid 84 and the outer lid 83 are deformed by virtue of a centrifugal load applied thereto so as to press the O-ring 87 against the body portion 80 side. Therefore, the O-ring 87 is secured tight to the inner lid 84 and the opening portion 81A of the sample container 80, whereby the sample does not leak out of the cap portion 82.

Normally, a force moving the outer lid 83 in the direction of acting centrifugal force is generated in the outer lid 83 by a centrifugal force generated during centrifugal separation. Because of this, a large load is generated in the vicinity of the opening portion 81A, and in the worst case, the sample container 80 may be deformed or fail in the vicinity of the opening portion 81A. In this embodiment, however, the neck support portion 83C is formed on the outer lid 83, and the neck support portion 83C is brought into contact with the inner wall of the holding hole 132 in a good fashion. Thus, the outer lid 83 can be prevented from being shifted in the direction of acting centrifugal force, thereby making it possible to realize the sample container 80 which has superior durability.

Thus, as has been described heretofore, by employing the sample container 80 according to the second embodiment, a large amount of sample can be processed at one time. In addition, the external shape of the body portion 81 of the sample container 80 is formed into the substantially triangular shape. Thus, when the operator grips on the body portion 81 by one hand and turns the cap portion 82 by the other hand, there can be obtained an advantage that the cap portion 82 can easily be turned. Further, the neck support portion 83C having the same shape as the external shape of the body portion 81 is formed integrally on the cap portion 82. Therefore, the operator does not have to worry about the failure to attach the neck support member which is prepared as the separate member, and the deformation or failure of the cap portion 82 and the portion in the vicinity of the opening portion 81A of the body portion 81 by the centrifugal force can be prevented. In addition, even when the centrifugal force is applied thereto, the outer circumferential portion of the outer lid 83 matches the shape of the holding hole 132 of the rotor 130 and fits in the holding hole 132 with forming no gap therebetween, whereby the opening portion 81A and the cap portion 82 of the sample container 80 can be prevented from being deformed or damaged by the centrifugal force.

### Third Embodiment

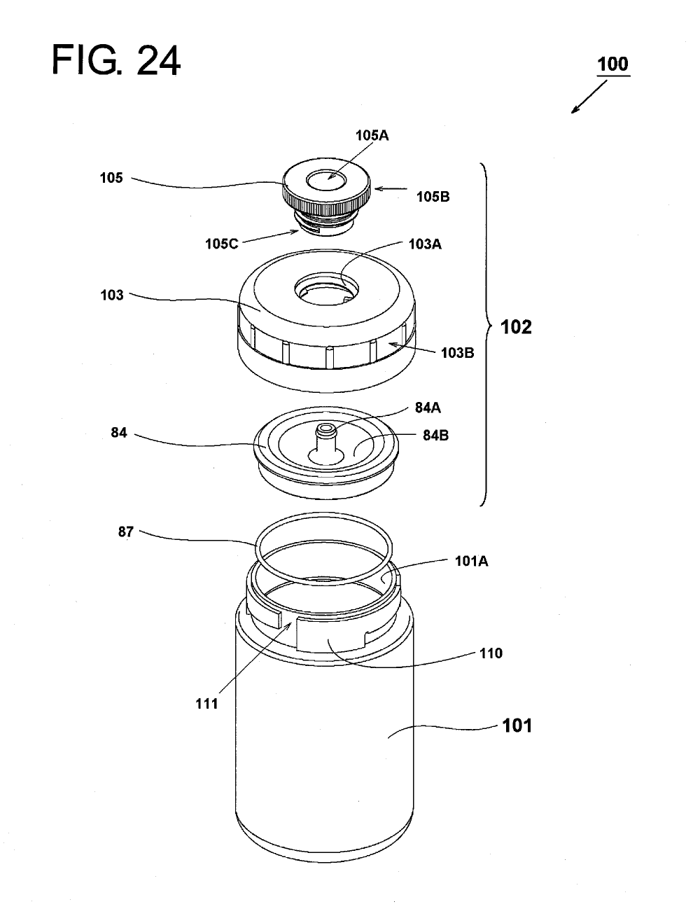

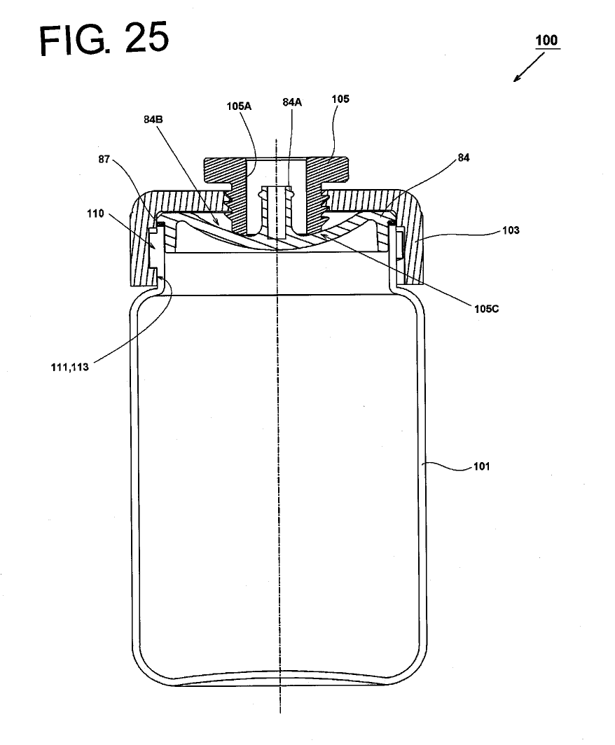

Next, a third embodiment will be described with reference to FIGS. 24 and 25. The opening and closing structure of the cap portion 82 in the second embodiment can be applied not only to the sample container having the substantially triangular shape when viewed from above which is described in the first embodiment but also to the sample container according to the related art which is described in FIG. 27. A sample container 100 according to the third embodiment has a cylindrical shape which is basically similar to the shape of the conventional sample container shown in FIG. 27. However, the sample container 100 adopts an engaging type fastening structure in which a cap portion 102 is pushed axially downwards relative to a body portion 101 and is turned clockwise to be fixed with the cap portion 102 remaining in almost the same structure as that of the second embodiment.

FIG. 24 is a perspective view showing an external appearance of a sample container 100 and shows a state in which a cap portion 102 is detached. The sample container 100 is divided into a body portion 101 and a cap portion 102. The body portion 101 is a portion of the container where a liquid sample to be subjected to centrifugal separation is contained. A circular opening portion 101A for putting in and taking out the sample is provided in an upper portion of the body portion 101, and the cap portion 102 is attached to the opening portion 101A. The cap portion 102 is made up of an outer lid 103, an inner lid 84, a push piece 105, and an O-ring 87. The inner lid 84 and the O-ring 87 can have the same structure as those of the second embodiment for use. An L-shaped groove portion 111 is formed in an outer circumferential surface of the opening portion 101A, and this L-shaped groove portion 111 constitutes an engaging unit. An engaging unit (which will be described later) is also provided on an inner surface of the outer lid 103 and this engaging unit is paired with the engaging unit of the opening portion 101A. L-shaped groove portions 111 are provided at equal intervals in a circumferential direction at a plurality of locations, preferably, at three locations at angular intervals of 120 degrees, whereby the cap portion 102 can be attached to the body portion 101 in a one-touch fashion. The cap portion 102 is engaged with the opening portion 101A and is then rotated until the engaging unit come into contact with terminating positions of the groove portions 111, whereby the cap portion 102 is fixed to the body portion 101. Following this, the push piece 105 is screwed into the outer lid 103, whereby the inner lid 84 is firmly secured to the opening portion 101A, and the sample container 80 is closed completely. The O-ring 87, which is a sealing member for sealing the opening portion 101A, is attached to the cap portion 102 and the opening portion 101A of the body portion 101, and the inner lid 84 is attached to the body portion 101 via the O-ring 87. Then, the outer lid 103 is provided so as to cover them.

A female thread 103A is provided in a central portion of an upper surface of the outer lid 103 into which the push piece 105 is screwed. A hole 105A, which penetrates the push piece 105 in an axial direction, is provided to extend upwards from a lower surface of the push piece 105, and a projecting portion 84A on the inner lid 84 is accommodated in the hole 105A so provided. A grip portion 105B is formed on an outer circumferential portion of the push piece 105 so that the operator can screw it into the outer lid 103 by the operator's hand. In the third embodiment, a number of vertical grooves are formed on the grip portion 105B so as to make it difficult for the hand of the operator to slip thereon. When the push piece 105 is screwed in, a lower surface 105C of the push piece 105 presses down an upper surface 84B of the inner lid 84, and the O-ring 87, functioning as the sealing member between the body portion 101 and the inner lid 84, is compressed to thereby ensure a sealing performance of the sample container 100. The body portion 101 of the sample container 100 has a cross-sectional shape (a shape resulting when viewed from above) which is a regular circle, and the material of the body portion 101 is the same as that of the body portion 51 of the first embodiment. Thus, the repetition of the same description will be omitted here.

FIG. 25 is a vertical sectional view of the sample container 100 according to the third embodiment. The body portion 101 has a circular cross section, and the body portion 101 and the outer lid 103 are formed so as to have the same external shape. Because of this, the external shape and dimensions of the sample container 100 are the same as those of the conventional sample container 250 shown in FIG. 27. Thus, the sample container 100 can be attached in the rotor 230 according to the related art. Also in the third embodiment, projecting portions 113 are partially formed on a cylindrical inner circumferential wall of the outer lid 103, and the outer lid 103 is fixed in such a state that the projecting portions 113 enter the groove portions 111. Consequently, thick portions 110 are positioned axially above the projecting portions 113, and therefore, the outer lid 103 is held on the body portion 101 without being dislodged therefrom. As this occurs, the O-ring 87 and the inner lid 84 are interposed between the opening portion 101A and the outer lid 103. An upper surface 84B of the inner lid 84 is pressed downwards by the lower surface 105C of the push piece 105.

According to the third embodiment that has been described above, in the cylindrical sample container having the same external shape as that of the conventional example, the engaging type opening and closing structure is adopted for the cap portion 102. Thus, when attaching the cap portion 102 on the body portion 101, the cap portion 102 is pushed axially relative to the body portion 101 and is then turned through about 60 degrees in a clockwise direction as viewed from above, whereby the cap portion 102 can easily be fastened on to the body portion 101. In addition, when removing it from the body portion 101, the cap portion 102 only has to be turned through about 60 degrees in a counterclockwise direction. Thus, the cap portion 102 can easily be attached to and detached from the body portion 101. Moreover, the closeness is increased by pressing the inner lid 84 by employing the push piece 105, and therefore, the leakage of sample during centrifugal operation can be prevented.

Thus, while the aspect of the invention has been described based on the embodiments, the invention is not limited to the embodiments that have been described and hence can be modified variously without departing from the spirit and scope of the invention. For example, while the rotor is formed through monolithic molding, a type of rotor which is formed separately or a swing rotor may be adopted. In addition, the shape of the sample container as viewed from above is not limited to the substantially regular triangular shape, and hence, a substantially isosceles triangular shape may be adopted.

What is claimed is:

1. A centrifuge sample container comprising:
a body portion configured to contain a sample and having a circular opening portion in an upper portion of the body portion; and
a cap portion configured to be engaged with and attached on the body portion,
wherein the body portion has a substantially triangular external shape defining three apex portions and three side portions between two of the apex portions when viewed from above,
wherein distances between centers of the apex portions are equal to one another,
wherein each of the apex portions is formed with a first radius of curvature when viewed from above, and
wherein each of the side portions is formed into a outwardly curved arc-like shape with a second radius of curvature when viewed from above.

2. The centrifuge sample container according to claim 1, wherein
an outline of the external shape of the body portion is located further outwards than the opening portion when viewed from above, and
a neck support portion having the same shape as the external shape of the body portion is formed on the cap portion.

3. The centrifuge sample container according to claim 2, wherein
the cap portion includes:
an inner lid which is secured in the opening portion while a closing member is interposed between an upper end face of the opening portion and the inner lid; and
an outer lid which is engaged with the body portion so as to cover the opening portion and the inner lid, and
the neck support portion is formed on the outer lid.

4. The centrifuge sample container according to claim 3 further comprising an engaging unit configured engage the cap portion with the body portion,
wherein the outer lid includes a lower inner circumferential surface formed into a cylindrical shape,
wherein when the cap portion is engaged with the opening portion by the engaging unit, the substantially triangular shape of the body portion coincides with a substantially triangular shape of the outer lid when viewed from above.

5. The centrifuge sample container according to claim 4, wherein
the engaging unit includes a projecting portion which is formed on the inner circumferential surface and projects radially inwardly,
the engaging unit includes a circumferential groove which is formed on an outer circumferential side of the opening portion, and
the cap portion is held so as not to be shifted in an axial direction when the projecting portion enters the circumferential groove.

6. The centrifuge sample container according to claim 5, wherein a plurality of the projecting portions are formed on the inner circumferential surface of the outer lid, and a plurality of the circumferential grooves are formed on the outer circumferential side of the opening portion.

7. The centrifuge sample container according to claim 5, wherein
the engaging unit includes:
an axial groove which is formed on the body portion extends from an opening surface of the opening portion in an axial direction; and
a circumferential groove which extends in a circumferential direction from a distal end side of the axial groove, and
the cap portion is pushed axial downwards relative to the body portion and is then turned through a predetermined angle so that the projecting portion is positioned in the circumferential groove.

8. The centrifuge sample container according to claim 7, wherein
a length of the circumferential groove which extends from the axial groove is set so that a rotation angle of the cap portion becomes smaller than about 120 degrees in the circumferential direction.

9. The centrifuge sample container according to claim 1, wherein
a through hole in which a thread is formed is provided in the outer lid, and
a push piece configured to push the inner lid is attached in the through hole.

10. A centrifuge sample container comprising:
a body portion configured to contain a sample and having a circular opening portion in an upper portion of the body portion;
a cap portion configured to be attached on the body portion;
an engaging unit configured engage the cap portion with the body portion,
wherein the cap portion includes:
an inner lid which is secured in the opening portion while a closing member is interposed between an upper end face of the opening portion and the inner lid; and
an outer lid which is engaged with the body portion so as to cover the opening portion and the inner lid, and
wherein the outer lid includes a lower inner circumferential surface formed into a cylindrical shape,
wherein the engaging unit is provided on an outer circumferential surface of the opening portion and the inner circumferential surface of the outer lid,
wherein a through hole is formed through the outer lid and a thread is formed on the through hole, and
wherein a push piece configured to push the inner lid is attached in the through hole.

11. The centrifuge sample container according to claim 10, wherein
the engaging unit includes a projecting portion which is formed on the inner circumferential surface and projects radially inwardly, and
the engaging unit includes a circumferential groove which is formed on the outer circumferential surface of the opening portion, and
the cap portion is held so as not to be shifted in an axial direction when the projecting portion enters the circumferential groove.

12. The centrifuge sample container according to claim 11, wherein a plurality of the projecting portions are formed on the inner circumferential surface of the outer lid, and a plurality of the circumferential grooves are formed on the outer circumferential side of the opening portion.

13. The centrifuge sample container according to claim 12, wherein
the engaging unit includes:
an axial groove which is formed on the body portion extends from an opening surface of the opening portion in an axial direction; and
a circumferential groove which extends in a circumferential direction from a distal end side of the axial groove, and
the cap portion is pushed axial downwards relative to the body portion and is then turned through a predetermined angle so that the projecting portion is positioned in the circumferential groove.

14. The centrifuge sample container according to claim 13, wherein
a length of the circumferential groove which extends from the axial groove is set so that a rotation angle of the cap portion becomes smaller than about 120 degrees in the circumferential direction.

15. A centrifuge comprising:
a rotor which includes a holding portion;
a motor which is configured to rotate the rotor;
a rotor chamber which accommodates the rotor; and
the centrifuge sample container described in claim 1, which is attached in the holding portion of the rotor.

16. A centrifuge comprising:
a rotor which includes a holding portion;
a motor which is configured to rotate the rotor;
a rotor chamber which accommodates the rotor; and
the centrifuge sample container described in claim 10, which is attached in the holding portion of the rotor.
